(19) United States
(12) Patent Application Publication
(10) Pub. No.: US 2015/0150268 A1
(43) Pub. Date: Jun. 4, 2015

(54) CONTINUOUS PROCESS AND APPARATUS FOR MAKING A PITA CHIP

(71) Applicant: Frito-Lay North America, Inc., Plano, TX (US)

(72) Inventors: Michelle Latrese Barnett, Plano, TX (US); Ponnattu Kurian Joseph, Irving, TX (US)

(21) Appl. No.: 14/615,026

(22) Filed: Feb. 5, 2015

Related U.S. Application Data
(63) Continuation-in-part of application No. 13/564,142, filed on Aug. 1, 2012.

(51) Int. Cl. A21C 5/00; B26D 7/06; A21D 8/06; B26D 7/32; A23L 1/164; A21D 8/02

(52) U.S. Cl. CPC A21C 5/00; A23L 1/164; A21D 8/02; A21D 8/06; B26D 7/32; B26D 7/0625; A23V 2002/00

(57) ABSTRACT

A method and apparatus for forming chips, for example, pita chips, from a continuous mass of dough. In a first aspect, the apparatus comprises a first conveyor, a second conveyor, and a first trimmer. The first conveyor and the second conveyor are spaced apart a distance to form a gap. The first trimmer, which can comprise a liquid jet nozzle, is positioned above the gap. In a second aspect, the method comprises using a first conveyor to convey a continuous mass of dough to a first trimmer positioned over a gap between the first conveyor and a second conveyor. The method also comprises using the first trimmer to longitudinally trim a first portion of the continuous mass of dough to form thinner strips of the continuous mass of dough. The thinner strips can be integral with the first portion.

### CROSS-REFERENCE TO RELATED APPLICATION

This application is a continuation-in-part of and claims filing priority rights with respect to currently pending U.S. patent application Ser. No. 13/564,142, filed on Aug. 1, 2012 which is incorporated by reference in its entirety as an illustrative example.

### TECHNICAL FIELD

The present invention relates to a method for making pita bread and chips and other such products in a continuous operation.

### BACKGROUND

Pita bread is a type of flatbread—typically a round pocket bread—believed to have originated in the Middle East. The baking process typically involves forming, by rolling, a flat dough disk that is baked in a hot oven, usually in excess of 260° C., on a flat support surface. The pocket inside the finished loaf is created during cooking when the outside layers of the bread are seared, thus forming a cap that impedes the release of steam from the interior of the bread. This trapped steam puffs up the dough in the middle of the bread thus forming a pocket. As the bread cools and flattens, a pocket is left in the middle that can be later stuffed for making sandwiches and the like.

Pita chips are generally made by splitting and cutting or chopping pita bread loaves into chip-sized pieces. Making individual round pita bread loaves and cutting each loaf into chip-sized pieces is time consuming and is not conducive to an efficient, continuous operation. One prior art approach to this issue involves pressing a dough ball between two hot plates to form the pita loaf, and then cutting the loaf into smaller chip sizes. This approach is referred to as a dough ball press method followed by splitting and chopping of the bread loaves. The dough ball press method is not particularly efficient and has not demonstrated desirable throughput rates on continuous or semi-continuous product lines.

FIG. 1A depicts a cross-section of a pita bread loaf 100 made with a dough ball press method. Traditionally, the pita bread 100 is split manually by pulling apart the top half 102 from the bottom half 104. The pita bread generally 100 breaks apart at its natural splitting point 106. While this manual process gives the pita bread 100 a natural, artisan bread look, this is an inefficient and time-consuming process.

One attempt at improving upon the dough ball press method is found in U.S. Pat. No. 6,291,002 entitled “Method for Preparing Elongated Pita Bread” issued on Sep. 18, 2001, to inventor George Goglanian (the “Goglanian Patent”). The Goglanian Patent describes a process whereby a sheet of dough is cut longitudinally into long strips. These strips are run through an oven, thereby producing a tube-shaped bread product. Because a tube shape is not conducive to making into a flat chip, the Goglanian Patent teaches cutting this tube along its longitudinal edges into a top half and a bottom half of the pita bread tubes. These sections are cut into chip shapes, thus making chips of both the top and the bottom of the tube.

Goglanian Patent still has several inefficiencies. First, Goglanian routes bread after it departs a bread oven to a spiral cooler. This means that the bread strips must be cut at a certain length and transported away from a continuous operation. This cooling process is inefficient because it requires manual handling of the intermediate bread product.

Second, Goglanian's process requires a lengthy curing process for the partially cooked tubes prior to being longitudinally split. The moisture level inside the bread is about 42%, while the moisture level at the surface of the bread is about 28% prior to curing. This ambient curing step must take place before the bread is either split or cut in the prior art. The curing allows for an equal distribution of moisture throughout the bread to about 32% moisture by weight. The ambient curing step typically takes between 8 and 24 hours. In order to accommodate such a long dwell time, the bread is physically removed from the processing line and manually placed in plastic bags during the ambient curing step. This ambient curing step is not conducive to an efficient continuous process.

Third, the tubes need to be cut along its cross-sectional center for optimal efficiency. If the tubes are cut off-centered, which normally occurs in practice, it results in significant product loss or wastage. The traditional mechanical splitting method results in significant product wastage. As shown in FIG. 1B, when the loaf 108 expands in the pita oven, variations exist in the thickness of the loaf sides 102, 104, making the natural splitting point 106 of the loaf difficult to identify. Ideally, a split between the upper half 102 and the lower half 104 should occur at the natural splitting point 106. When split mechanically, a pita loaf 108 is fed through a set of rollers and split at its mechanical center reflected by the location of the cutting devices rather than at the natural splitting point 106. As a consequence, the cutting device splits the upper half 102 from the lower half 104 at some point above or below the naturally formed intersection 106. For example, as shown in FIG. 1B, the bottom half 104 is much thicker than the top half 102. If the cutting device splits the loaf 108 at the midpoint of its height, the top half 102 will have two layers. Later during the processing, the top half 102 further split into two pieces or the thinner layer crumbles. This is part of the reason why an inefficient separation and wastage due to product breakage results.

Consequently, a need exists for a process that produces pita chips more efficiently. Such process should be capable of throughput rates typical of sheeter lines and minimize plant footprint used by the equipment. It would also be desirable if the invention could produce pita bread and/or chips with a more natural, artisan appearance.

### SUMMARY OF THE INVENTION

In accordance with one aspect of the present invention, an improved continuous process and apparatus for making a pita chip is provided which substantially eliminates or reduces disadvantages associated with previous systems and methods.

One embodiment of the process disclosed herein involves sheeting bread dough into a continuous dough sheet; cutting the continuous dough sheet longitudinally into continuous dough strips; cooking a continuous dough strip in a continuous oven, thereby producing a continuous bread tube, wherein the continuous bread tube comprises a cavity, a top surface, and a bottom surface; curing the continuous bread tubes in less than about 60 seconds; and trimming the continuous bread tubes into chip-sized pieces using a trimmer.

In some embodiments, the continuous, accelerated curing step occurs in a radio frequency oven. In most embodiments, the curing step is complete in less than about 60 seconds. In embodiments where the continuous bread tubes are split longitudinally, a convection oven is optionally used.

In some embodiments, the dough sheets undergo a proofing before cooking In some embodiments, the continuous bread tube is sprayed with anti-adhesive liquid to remove tackiness from its surfaces. In one embodiment, trimming exposes the inner cavity (or the crumb side) of the continuous bread tubes. In other embodiments, the inner cavity is exposed by splitting the continuous bread tubes longitudinally.

Another embodiment of the process disclosed herein involves sheeting bread dough into a continuous dough sheet; cutting the continuous dough sheet longitudinally into continuous dough strips; cooking a continuous dough strip in a continuous oven, thereby producing a continuous bread tube, wherein the continuous bread tube comprises a cavity, a top surface, and a bottom surface; splitting the continuous bread tube longitudinally into a top half and a bottom half using a splitting mechanism assisted by vacuum technology; curing the continuous bread tube in less than about 60 seconds; and trimming the continuous bread tubes into chip-sized pieces using a trimmer.

In some embodiments, transporting the continuous bread tubes is accomplished using a top vacuum conveyor, wherein the top vacuum conveyor is coupled to the top surface of the continuous bread tube. In another embodiment, the continuous bread tube is transported using a bottom vacuum conveyor registered with the top vacuum conveyor, wherein the bottom vacuum conveyor is coupled to the bottom surface of the continuous bread tube. In an alternative embodiment, the splitting mechanism is coupled to vacuum rollers.

In some embodiments, a filling is applied between the top half and the bottom half of the bread tube. In one embodiment, the top and the bottom halves of the continuous bread tube are transported together using a single-tier takeaway conveyor. Alternatively, the top and bottom halves of the continuous bread tube are transported separately using a top takeaway conveyor and a bottom takeaway conveyor, respectively.

In some embodiments, the invention provides an apparatus for forming chips, for example, pita chips, from a continuous mass of dough. In one embodiment, the apparatus comprises a first conveyor, a second conveyor, and a first trimmer. The first conveyor and the second conveyor are spaced apart a distance to form a gap. The first trimmer, which can comprise a liquid jet nozzle, is positioned above the gap.

In one embodiment, the invention provides a method for forming chips. The method comprises using a first conveyor to convey a continuous mass of dough to a first trimmer positioned over a gap between the first conveyor and a second conveyor. The method also comprises using the first trimmer to longitudinally trim a first portion of the continuous mass of dough to form thinner strips of the continuous mass of dough. The thinner strips are integral with the first portion.

In one embodiment, the invention provides an apparatus for splitting dough longitudinally to form a first portion of dough and a second portion of dough. The apparatus comprises a first roller, a second roller, and at least one source of vacuum. The at least one source of vacuum provides a first vacuum in the first roller and a second vacuum in the second roller. The first roller and the second roller are spaced apart a distance so that the dough can pass between.

In one embodiment, the invention provides a method for splitting dough. The method comprises providing dough with a first portion and a second portion; conveying the dough between a first roller and a second roller; exposing the first portion to a first vacuum within the first roller, rotating the first roller; exposing the second portion of dough to a second vacuum within the second roller; and rotating the second roller.

Certain embodiments of the present invention may provide a number of technical advantages. For example, according to one embodiment, the pita chip production process is fully or substantially continuous with minimal amount of manual handling and significantly shorter cooling or curing times. Another technical advantage in particular embodiments is uniform pita chip product with decreased product wastage. Also, some embodiments of the disclosed process produce continuous bread tubes with less wrinkled surface, which results in further reduction of product wastage during the optional splitting step. Furthermore, some embodiments produce split pita chips with crumb exposure while other embodiments produce two-layered pita chips. Yet another technical advantage associated with one embodiment of the present invention is its versatility. Several steps in the disclosed process may be interchanged in the sequence. The disclosed process, along with the accompanying equipment, provides for a continuous process that produces pita chips that eliminates lengthy curing and cooling times and minimizes wastage. Such a process provides for substantially increased throughput and minimal plant footprint.

The inventors of the presently disclosed invention also realized another problem that can occur as partially cooked dough for pita bread exits an oven to be cut before being finish cooked. Namely, the dough can be difficult to cut using mechanical cutting devices (e.g. rotary blades, band saws or other equipment that contacts the bread). For example, the dough can be hot (e.g. 75-100° C., which is about 167-212° F.) and stick to or build up on a cutting blade. Therefore, a non-mechanical solution for continuously cutting the dough is needed to overcome these and other problems.

Accordingly, in one embodiment, the invention provides a non-mechanical solution for continuously cutting bread. For example, one embodiment utilizes trimmers that comprise a water jet cutter to cut dough or partially cooked dough in the form of bread tubes. The trimmers use pressurized jet streams of water to cut the dough in the longitudinal and lateral direction. The lateral trimmer is positioned over a mesh conveyor belt. Because the water jets for cutting in the lateral direction quickly traverse back and forth across the mesh conveyor belt, the lateral trimmer does not spend much time over any given portion of the dough and not much water is absorbed by the dough.

In one embodiment, the longitudinal trimmer is stationary and cuts dough as a conveyor belt moves dough past the longitudinal trimmer. Since the conveyor belt only moves at a fraction of the speed of the lateral trimmer, the longitudinal trimmer spends much more time over a given portion of the dough. Consequently, even if the longitudinal trimmer is placed over a mesh conveyor belt, the dough can absorb a substantial amount of water from the longitudinal trimmer. For some products, this water needs to be removed later by a drying process. For these products, the absorption of water can be undesirable.

Accordingly, a need also exists for cutting dough or partially cooked dough in the longitudinal direction while limiting water uptake and without using a mechanical cutter (e.g., with a blade) that is likely to have problems with sticking and the build-up of dough. In one embodiment, the inventors have provided a solution for this need by positioning two conveyors to provide a gap between the two conveyors and then positioning a longitudinal water jet trimmer above the gap. As dough or partially cooked dough travels past the water jet trimmer on the conveyors the trimmer cuts the dough or partially cooked dough. The dough travels past the longitudinal trimmer at a relatively low speed compared to the speed with which the lateral trimmer moves over the dough (e.g. the dough travels at around 1/10 of the speed of the lateral trimmer). Nonetheless, by using the inventive embodiment, substantially less water is absorbed by the dough than would occur if the water jet trimmer were positioned over a mesh conveyor. For example, the embodiment prevents water from splashing against the mesh conveyor and onto the dough.

Additionally, the invention provides enhanced cut precision and quality compared to a conventional mechanical cutter. For example, enhanced quality includes reducing the amount (e.g., weight and/or volume) of crumbs that are produced during cutting. Because crumbs represent a separation and/or loss of material from the dough, they can be undesirable.

The precision and quality of a cut typically increases after dough is cured. However, the present invention can provide a desired level of cut precision and quality with less curing time compared to a mechanical cutter. For example, even when the invention is used on a partially cooked dough that has only been cured for about 60 seconds or less, the invention can provide the same precision and quality of cut that a mechanical cutter provides when the mechanical cutter is used on partially cooked dough that has been cured for 12 hours. In other words, when cutting dough with the present invention as opposed to a mechanical cutter (e.g., a band saw or rotating saw), less or no curing time is necessary to obtain a desired cut precision and quality.

As yet another advantage, the embodiment can be used in a continuous process, for example, a fully or substantially continuous process for producing pita chips as described herein.

As another benefit, one embodiment of the invention comprises vacuum rollers that can be used to pull apart a dough with or without assistance from cutting equipment. This provides better cutting or splitting performance compared to simply using a vacuum to provide traction to keep the dough from slipping as it is cut. Additionally, using vacuum rollers provides a cut with a more natural, artisan look.

The vacuum rollers can also be relatively energy efficient compared to other types of conveyors, for example, a conveyor belt. One reason for this is that the vacuum is provided on a relatively small area of a roller, rather than a relatively large area on a conveyor belt. Providing a vacuum for a smaller area requires less energy expenditure than providing the same vacuum in a larger area.

These and other advantages will be evident to a person having ordinary skill in the art after reading the present disclosure.

### BRIEF DESCRIPTION OF THE DRAWINGS

For a more complete understanding of the present invention and its advantages, reference is made to the following description, and the accompanying drawings, in which:

FIG. 1A is a cross-sectional view of the prior art manual splitting of a pita loaf;

FIG. 1B is a cross-sectional view of the prior art mechanical splitting of a pita loaf;

FIG. 2 is a flow chart showing the steps of one embodiment of Applicants' method;

FIG. 2A is a flow chart showing the steps of one embodiment of Applicants' method;

FIG. 3A is a cross-sectional view of one embodiment of Applicants' splitter;

FIG. 3B is a schematic view of one embodiment of Applicants' splitter;

FIG. 3C is a schematic view of one embodiment of Applicants' splitter;

FIG. 3D is a schematic view of one embodiment of Applicant's vacuum rollers for splitting dough;

FIG. 3E is a schematic view of one embodiment of Applicant's vacuum rollers depicting stationary vacuum manifolds;

FIG. 3F is a schematic view of one embodiment of Applicant's vacuum rollers depicting takeaway conveyors and cutting equipment;

FIG. 3G is a schematic view of one embodiment of Applicant's vacuum rollers depicting cutting equipment;

FIGS. 4A and 4B are schematic views of two embodiments of the take away conveyors downstream of the splitting unit;

FIG. 5 is a schematic side cut away view of one embodiment of Applicant's water jet cutting unit; and

FIGS. 6A and 6B are cross-sectional views of one embodiment of Applicant's strip cutting unit.

FIG. 7 is a schematic view of one embodiment of Applicants' chip cutting unit

FIG. 8 is a flow chart showing the steps of one embodiment of Applicants' method.

FIG. 8A is a flow chart showing the steps of one embodiment of Applicants' method.

FIG. 9A is a schematic view of an embodiment of Applicants' invention depicting a longitudinal trimmer over a gap between two conveyors.

FIG. 9B is a schematic view of an embodiment of Applicants' invention depicting a longitudinal trimmer over a support that is placed in a gap between two conveyors.

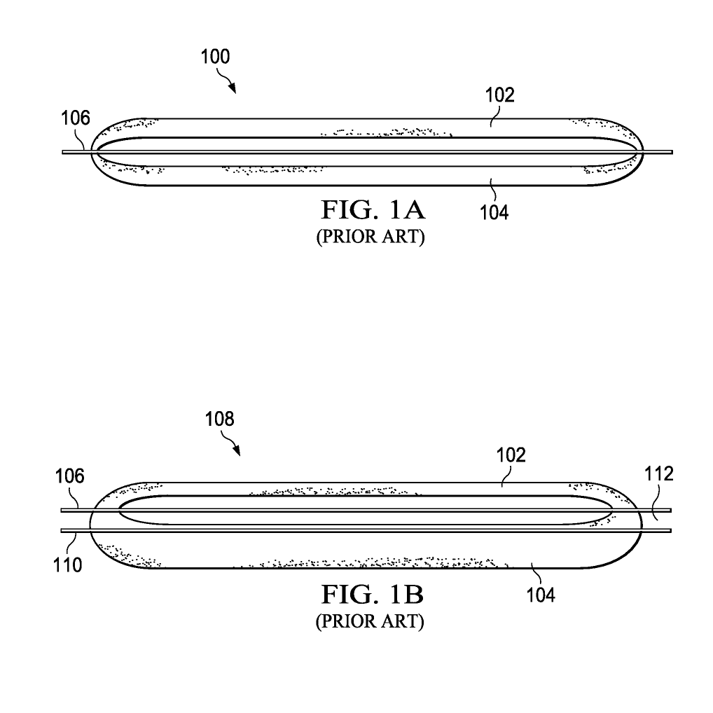

### DETAILED DESCRIPTION

It should be understood at the outset that although illustrative implementations of one or more embodiments are provided below, the disclosed systems and methods may be implemented using any number of techniques. The disclosure should not be limited to the illustrative implementations, drawings, and techniques illustrated below, but may be modified within the scope of the appended claims along with their full scope of equivalents. Unless otherwise noted, like elements will be identified by identical numbers throughout all figures.

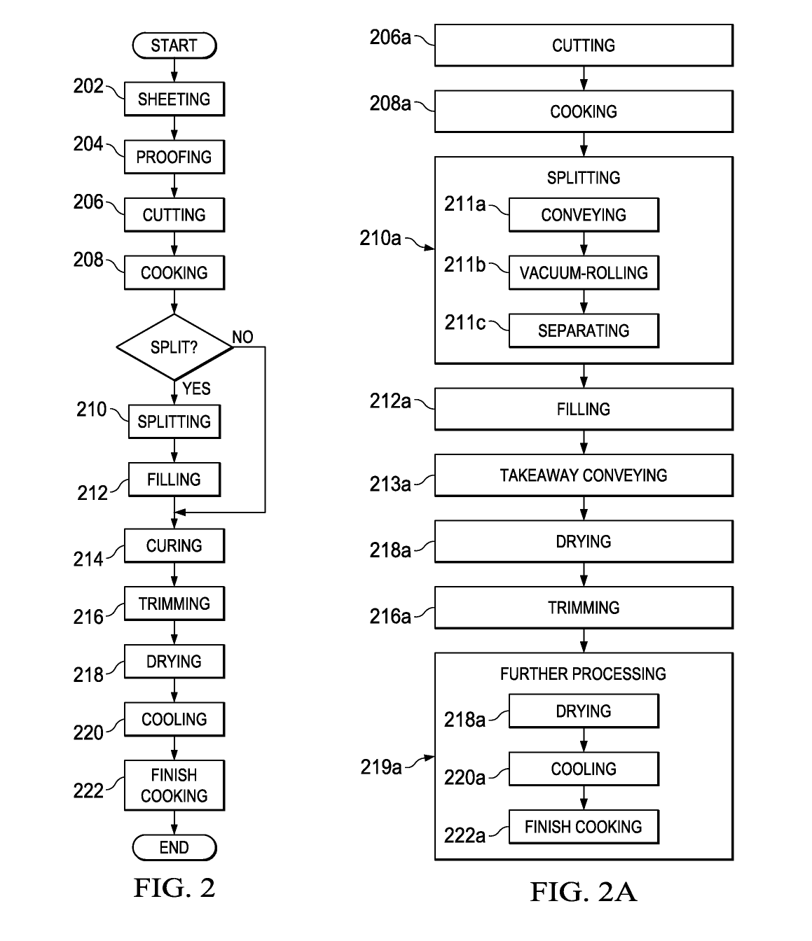

FIG. 2 shows one embodiment of Applicants' process 200 illustrating various steps in the process 200 pursuant to embodiments of Applicants' invention. After mixing of a bread dough, the dough is sheeted 202 into a continuous sheet of dough. In one embodiment, the dough sheet is optionally proofed 204. The dough sheet is then cut 206 into two or more continuous dough strips. Depending on the embodiment practiced, the dough strips proceed directly from the sheeting step 202 to a cooking step 208, or emerge from the proofing step 204 to proceed to the cooking step 208 to form bread tubes. In some embodiments, the bread tubes are optionally split 210 longitudinally. In other embodiments, bread tubes proceed to subsequent steps as unsplit tubes to produce two-layered pita chips. Bread tubes are optionally filled 212 with fillings after the splitting step 210. Optionally, the bread tubes are cured in an accelerated curing step 214. Although, the curing step 214 is shown after filling 212 and before trimming 216, curing can also occur immediately after splitting 210. In one embodiment, a water jet trimmer is used at step 216 to cut the bread tubes into chip-sized pieces. The chip-sized pieces are optionally dried 218 and cooled 220 to remove excess moisture from the water jet trimming step 216. The chip-sized pieces are then finish cooked 222 to produce a final product. In various embodiments, as further described below, Applicants' process 200 is capable of interchanging the sequence of some of these steps. In various embodiments, Applicants' process 200 is carried out with a continuous system having a plurality of unit operations. As used herein, a unit operation means a component of the continuous system operable to carry out one or more steps of the process 200. For example, the cooking step 208 occurs in an appropriate unit operation, which, in one embodiment, would be a continuous cooking oven. Another example of unit operation is the water jet trimmer used at the trimming step 216. Other unit operations will be described in further detail below.

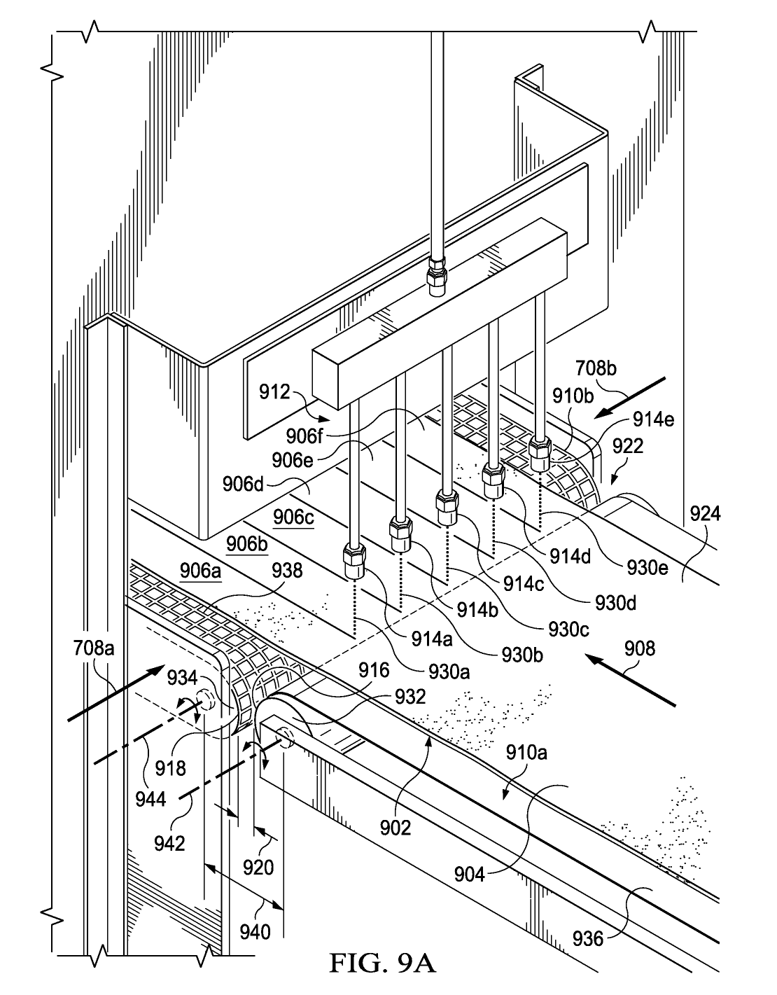

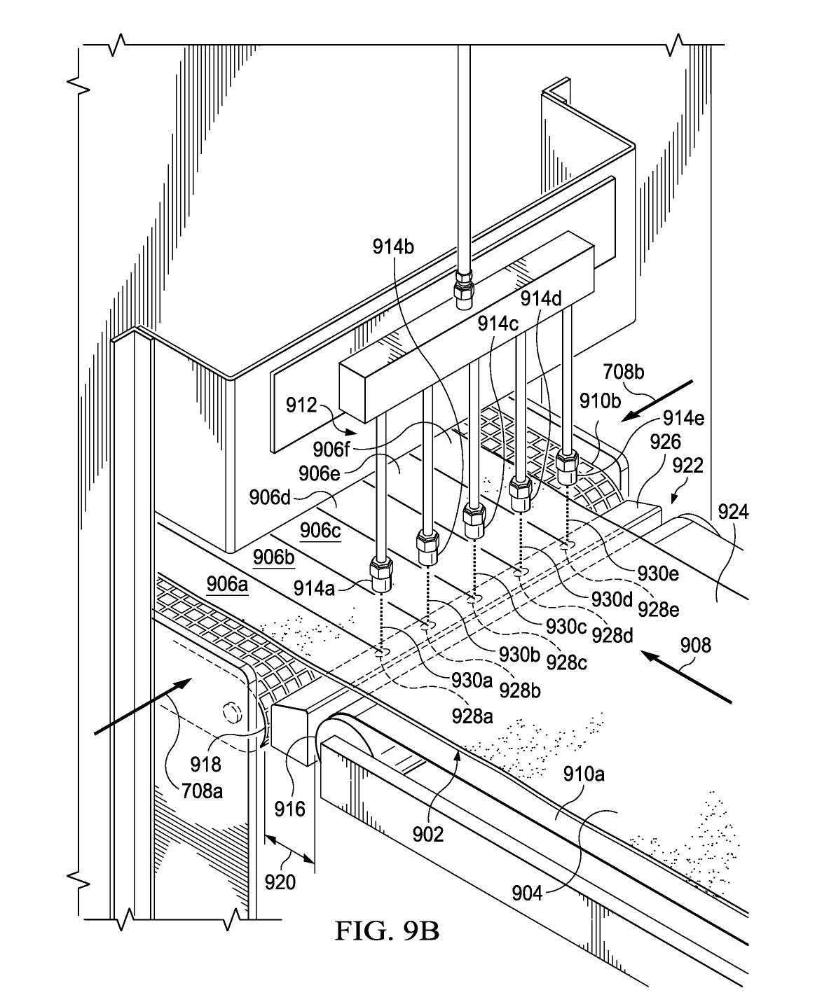

One embodiment of Applicant's invention will now be described with reference to FIG. 2A. First, in a providing step (e.g., by a cutting step 206a), a continuous mass of dough 902 (e.g., one of at least one continuous mass of dough) is provided. In one embodiment the dough can be provided on a conveyor (e.g., conveyor 910a in FIG. 9A). The at least one continuous mass of dough 902 can take many forms. In one embodiment, it is at least one fully continuous pita dough strip. In one embodiment, a plurality of continuous masses of dough are provided in parallel by trimming a single sheet of dough prior to cooking in an oven to form bread tubes.

The continuous mass of dough 902 is provided at a sufficient rate to keep up with the speed of the production line and a desired product manufacturing rate. For example, in some embodiments, the speed of the production line, and therefore conveyors for the continuous mass of dough 902, have a translational velocity that ranges from about 10 to 100 feet per minute. Although, in other embodiments, faster or slower speeds can be used.

The dough can be provided in a plurality of sizes. For example, in some embodiments, the thickness of the continuous mass of dough 902 ranges from about 0.05 to about 0.5 inches. In other words, this is the approximate thickness of some embodiments of the dough before a cavity is formed between two portions of the dough as a result of cooking About 0.05 to about 0.5 inches can also be the approximate thickness of a cooked embodiment of the dough calculated based upon the thickness 384 of a first portion (e.g., top) and the thickness 386 of a second portion (e.g., bottom), but excluding any intervening gap 380 between the portions. In some embodiments, the width of the continuous mass of dough 902 is about the same width as the diameter of a typical pita bread (e.g., about 3 to about 12 inches). Although, other sizes are also possible.

In one embodiment, the processing equipment for the continuous mass of dough 902 is sized to handle a given size and configuration of the dough. For example, in one embodiment, the width of a conveyor (e.g., conveyor 910a) and a processing line ranges from about 10 to about 60 inches.

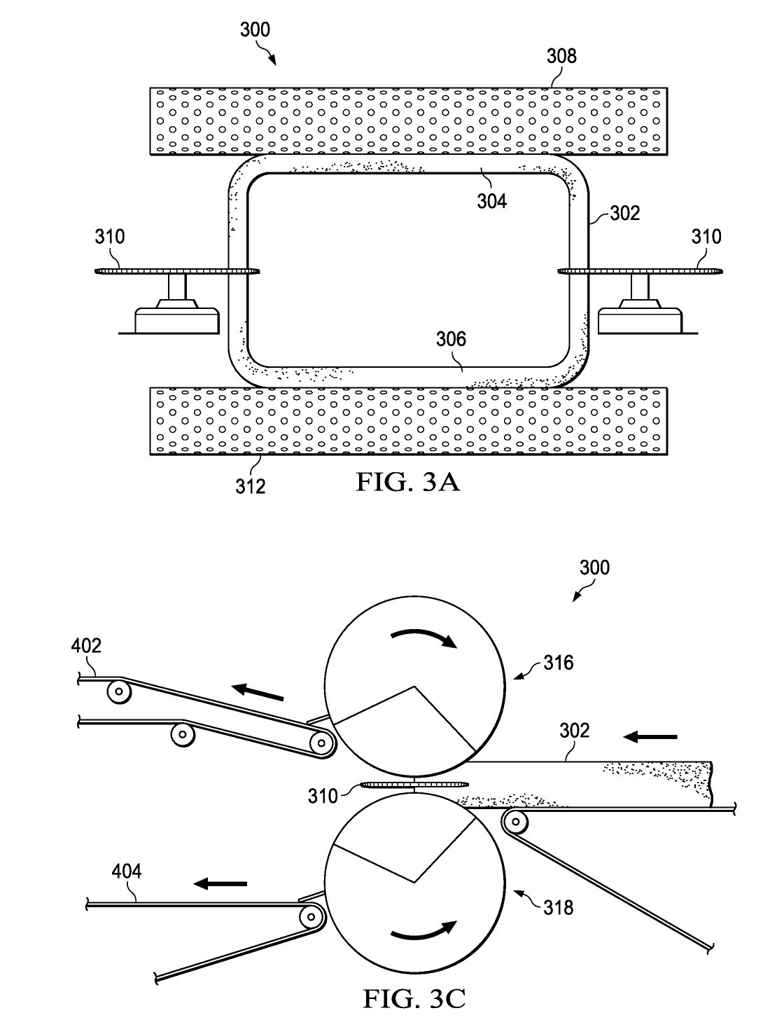

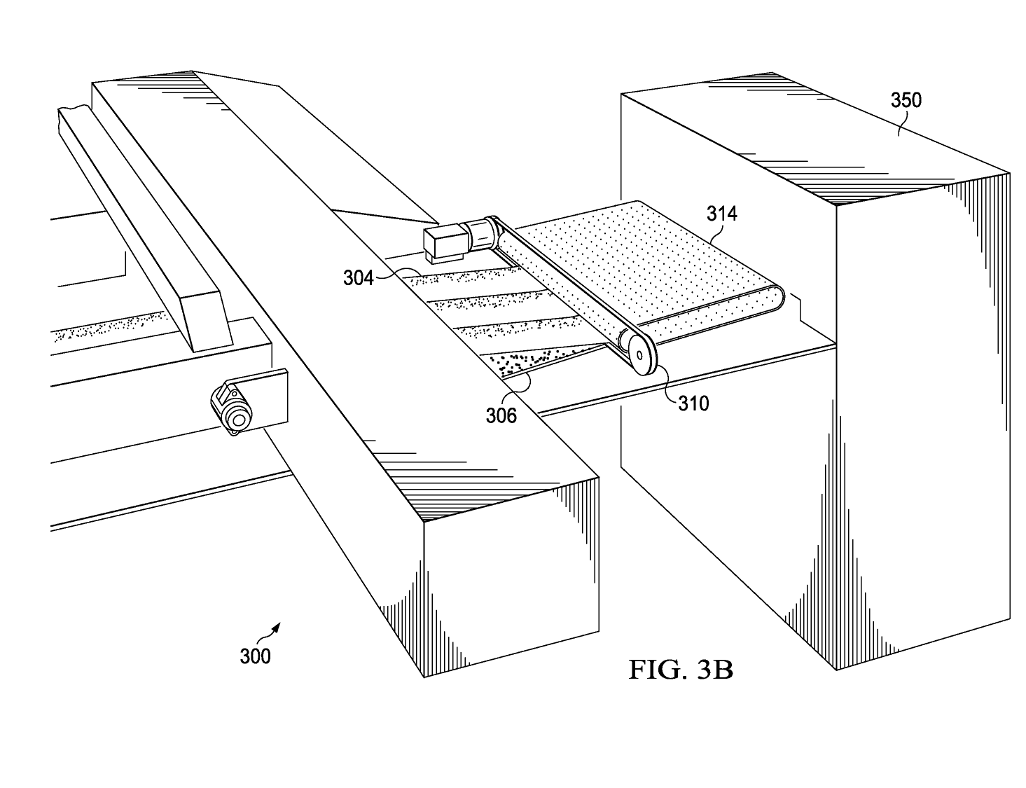

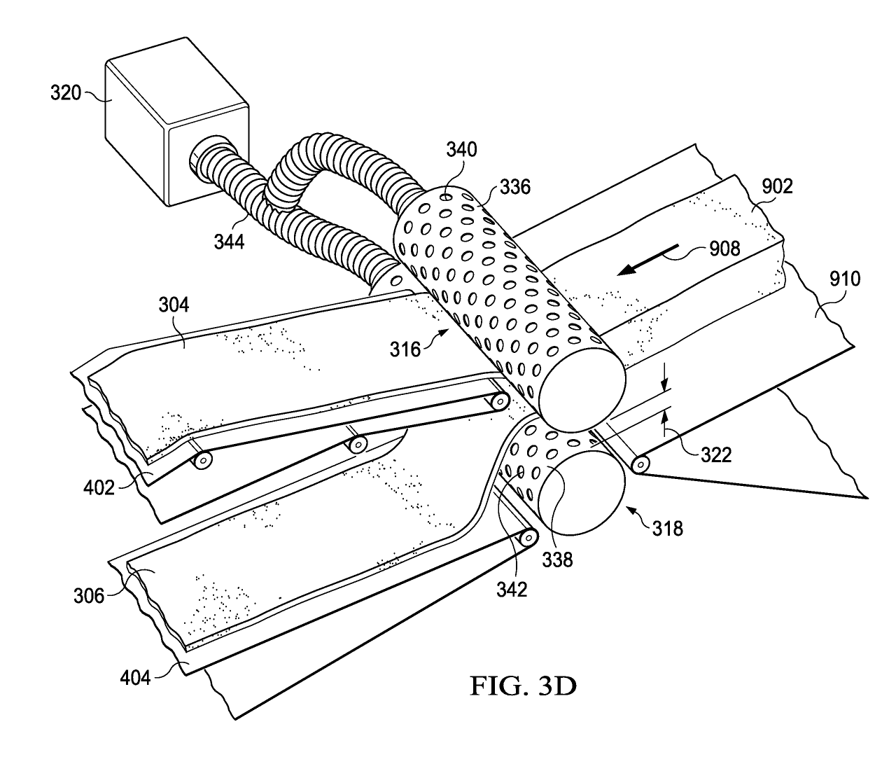

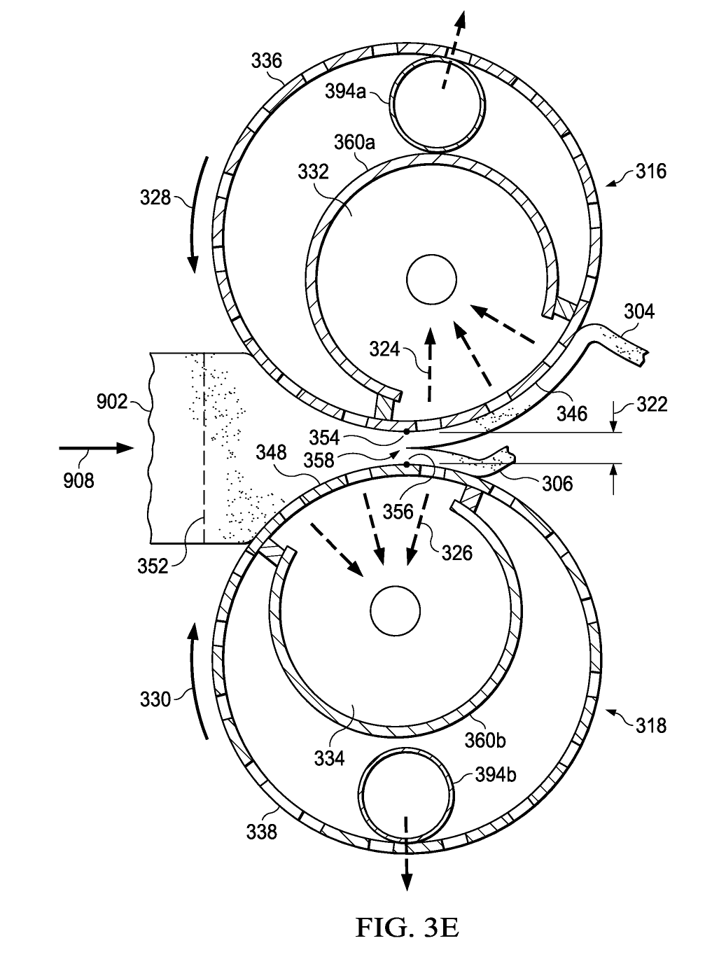

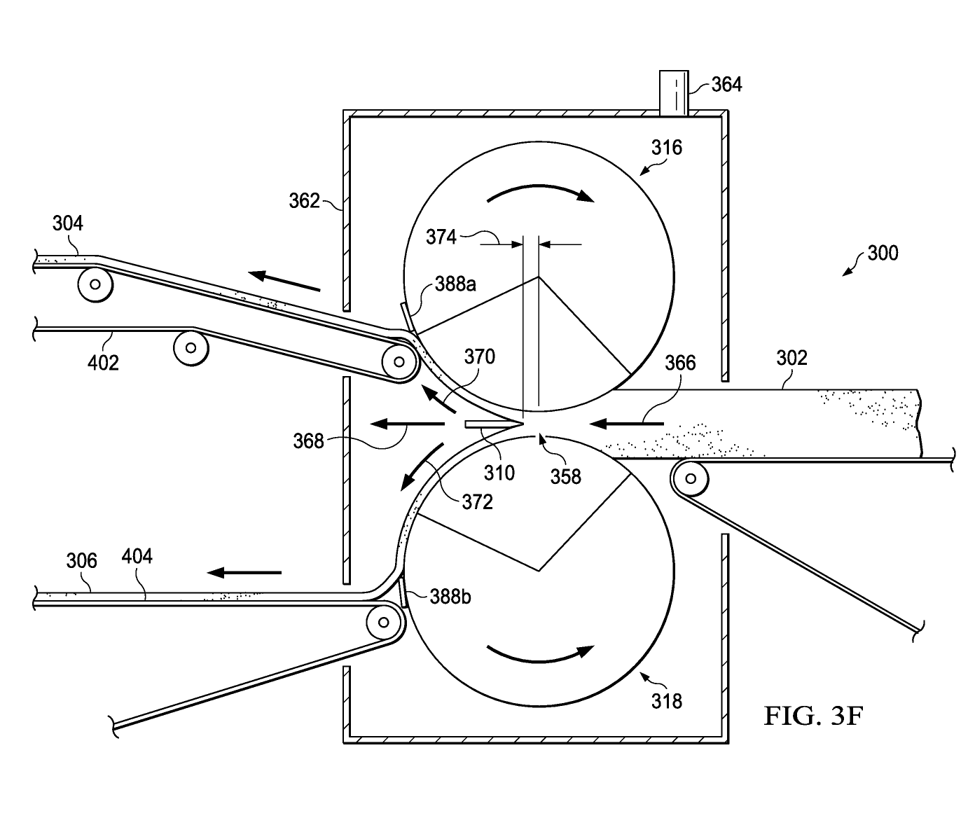

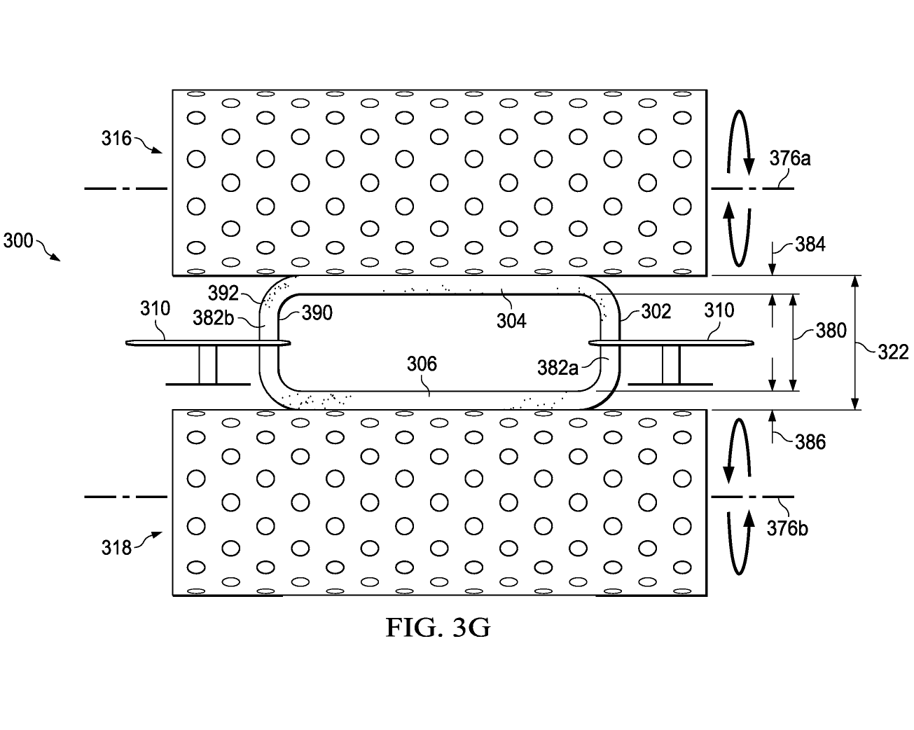

In light of the inventive fully or substantially continuous nature of one embodiment of the invention, the size and configuration of processing equipment can also be optimized to provide efficiency with respect to time, space, energy, and costs. For example, a conveyor at the inlet to an oven (e.g., oven 350 in FIG. 3B) for the continuous mass of dough 902 can be fully covered in dough until cooking changes the size and/or shape of the dough. Furthermore, because the dough is continuous, the full length of the oven 350 can be used. This results, for example, in a more efficient use of the cooking energy provided by the oven 350 and can also result in savings by reducing the equipment size required to produce a desired amount of product (e.g., pita chips 706 in FIG. 7).

Returning to FIG. 2A, one embodiment of the invention comprises cooking 208a as a second step. In the cooking step 208a, the continuous mass of dough 902 is baked in a continuous oven (e.g., continuous oven 350) to form at least one partially cooked dough (e.g., bread tube 302 with top and bottom halves 304,306 as shown in FIG. 3A). In one embodiment, the at least one partially cooked dough 302 is at least one fully continuous, hollow pita bread tube. In one embodiment, the pita bread tube is hollow because a top portion 304 of the bread tube is separated a distance from a bottom portion 306 of the bread tube. For example, in some embodiments, while the bread tube is still warm, hot vapor inside the bread tube provides a pressure that separates the top portion 304 from the bottom portion 306 of the bread tube.

With reference again to FIG. 2A, a third step is a splitting step 210a. In the splitting step 210a, the partially cooked dough 302 is split into a first portion of dough 304 and a second portion of dough 306. In one embodiment, as shown in FIG. 3F, the invention comprises a splitter housing 362 to capture steam from within the continuous mass of dough 902 as it is split. The captured steam is evacuated by utility equipment selected from the group consisting of a vacuum and a vent 364 (e.g., exhaust pipe). The splitter housing can be used when separating portions of dough using vacuum rollers without cutting equipment or when using cutting equipment.

As shown in FIG. 2a, the splitting step 210a can comprise several subsidiary steps.

For example, in a subsidiary conveying step 211a the partially cooked dough 302 is conveyed into the nip (e.g., nip 358 in FIG. 3E) of a first roller 316 and a second roller 318, which are mounted transversely to the long or continuous dimension of the dough 902. As used herein, a nip 358 is the region between the first and second roller 316,318 where the first and second roller 316,318 are closest. In addition to other benefits, conveying the continuous mass of dough 902 through the nip 358 of the first and second roller 316,318 can be useful to handle any level of pillowing that occurs when the continuous mass of dough 902 is a partially cooked dough 302.

Furthermore, when the partially cooked dough 302 is in the form of a bread tube, immediately conveying the tube from the oven (e.g., continuous oven 350) to the nip 358 can also be helpful. In this context, immediately means before the top 304 of the bread tube mends to the bottom 306 of the bread tube. For example, mending can occur if the top 304 of the bread tube collapses onto the bottom 306 of the bread tube due to cooling. However, as shown in the embodiments of FIGS. 3D and 3E, the first roller 316 and the second roller 318 are hollow with perforated surfaces and a vacuum is provided within each of the rollers. If the bread tube 302 reaches the rollers before it collapses, suction from the first roller 316 and the second roller 318 can hold the top 304 and bottom 306 of the bread tube apart and thereby prevent mending.

The splitting step 210a can also comprise a subsidiary vacuum-rolling step 211b. For example, as shown in FIG. 3F, in some embodiments, the continuous mass of dough 902 is conveyed to the first roller 316 and the second roller 318 in a pre-roller direction 366 with a pre-roller translational velocity. Then, in the subsidiary vacuum-rolling step 211b, a first portion of dough 304 is exposed to a first vacuum in the first roller 316, a second portion of dough 306 is exposed to a second vacuum in the second roller 318, and both the first roller 316 and the second roller 318 rotate. The suction and rotation of each roller provides a force that conveys the dough 902 in a post-roller direction 368 with a post-roller translational velocity. The dough's pre- and post-roller directions 366, 368 and translational velocities can be different or substantially the same. When the translational velocities are different, it can be useful if they are only slightly different (e.g., one velocity is about 100% to about 105% of the other velocity).

In practice, the rollers 316, 318 can also provide different portions 304, 306 of the dough 902 with different directions 370, 372 and translational velocities. Furthermore, the direction of the dough can change as the rollers 316, 318 rotate. Providing the first portion of dough 304 with a different translational velocity than the second portion of dough 306 can help separate the first and second portions and can be especially useful if cutting equipment 310 is not used during the splitting step 210a. For example, if a first roller 316 and second roller 318 are in contact with a continuous mass of dough 902 (e.g., partially cooked dough 302), the first roller 316 can be rotated to convey a first portion of dough 304 in a first post-roller direction 370 at a first translational velocity and the second roller 318 can be rotated to convey a second portion of dough 306 in a second post-roller direction 372 at a second translational velocity. Depending upon process conditions and/or equipment in use, the first and second translational velocities can be different or substantially equal.

In some embodiments, the vacuum-rolling step 211b makes use of stationary vacuum manifolds 360a,b within the rollers. For example, as shown in FIG. 3E, the first roller 316 comprises a first stationary manifold 360a, which generally limits vacuum suction to a vacuum portion of the first roller 316. Similarly, the second roller 318 comprises a second stationary manifold 360b, which generally limits vacuum suction to a vacuum portion of the second roller 318. Furthermore, as shown in FIG. 3E, the vacuum portion of the first roller 316 and the vacuum portion of the second roller 318 are positioned substantially or fully opposite each other and adjacent to the nip 358 (e.g., with the nip 358 between the vacuum portions). This can, for example, enable the vacuum rollers to pull a first portion of dough 304 away from a second portion of dough 306. In addition to holding dough against the first roller 316 and the second roller 318, the vacuum within the rollers can be used to evacuate steam that has been captured in the splitter housing 362, which is shown in FIG. 3F. Additionally, in one embodiment, the axes of rotation of the first and the second roller are positioned substantially horizontally. However, in another embodiment, the axes of rotation are positioned substantially parallel to each other but the positions of the axes are at an angle to horizontal. For example, the positions of the rollers relative to the dough can be at some position other than 12:00 and 6:00. For example, if the dough illustrated in FIG. 3G were superimposed on a clock with the dough being conveyed out of the center of the clock, a first roller could be said to contact the dough at the 12:00 position and a second roller could be said to contact the dough at the 6:00 position. However, in another embodiment, a first roller could contact the dough at the 1:00 position and a second roller could contact the dough at the 7:00 position.

With reference again to FIG. 2A, the splitting step 210a can also comprise a separating step 211c. In the separating step 211c, a first portion 304 of the continuous mass of dough 902 is separated from a second portion 306 of the continuous mass of dough 902. When cutting equipment 310 is used, the first roller 316 and the second roller 318 can be used to convey the continuous mass of dough 902 against the cutting equipment 310. For example, as shown in FIG. 3F, the first roller 316 and the second roller 318 can convey the continuous mass of dough 902 against the cutting edge of a blade, thereby splitting a leading edge of the continuous mass of dough 902 into a first portion of dough 304 (e.g., first half) and a second portion of dough 306 (e.g., second half). In some embodiments, the cutting equipment comprises a rotary blade. In other embodiments, the cutting edge comprises a cutting edge that is stationary or essentially stationary. For example, the cutting edge of an ultrasonic cutter can be essentially stationary, but vibrate at a high frequency, which can help prevent the build-up of dough on the blade. Alternatively, an ultrasonic cutter can comprise a rotary blade. It can be advantageous to orient an ultrasonic blade in a substantially horizontal plane.

In one embodiment, as shown in FIG. 3F, cutting equipment 310 (e.g., an ultrasonic cutter) comprising a blade is positioned where the continuous mass of dough 902 exits a nip 358 between the first roller 316 and the second roller 318. The cutting edge of the cutting equipment 310 is positioned a distance 374 (e.g., about 0 to about 1 inch) downstream of a nip 358 between the first roller 316 and the second roller 318. As can be seen in FIG. 3G, the cutting edge is positioned parallel to the axes of rotation 376a,b of the first roller 316 and the second roller 318. Additionally, the cutting edge of the blade is positioned to split the continuous mass of dough 902 into the first portion 304 (e.g., first half) and the second portion 306 (e.g., second half). In one embodiment, the cutting edge of the cutting equipment 310 is positioned at the midway point of the nip 358 between the first roller 316 and the second roller 318.

As shown in FIG. 3G, the size of the nip 358 between (e.g., the distance 322 between) the first roller 316 and the second roller 318 is selected so that the first portion of dough 304 that is fixed to the first roller 316 and the second portion of dough 306 that is fixed to the second roller 318 are separated by an intervening gap 380. In some embodiments, the intervening gap provides short and taught connective faces 382a,b (e.g., vertical sides) between the first portion of dough 304 and the second portion of dough 306. As shown, the first roller 316 and the second roller 318 convey each connective face 382a,b against at least one piece of cutting equipment 310 (e.g., a first connective face 382a can be conveyed against a first piece of cutting equipment 310 and a second connective face 382b can be conveyed against a second piece of cutting equipment 310. In some embodiments, the continuous mass of dough 902 between the first roller 316 and the second roller 318 comprises an annular cross section that can be rectangular (see, e.g., the rectangular shape of the annular cross section of the bread tube 302 in FIG. 3G.

In one embodiment, the size of the nip 358 is selected based on the size of a bread tube 302 that is fed between the nip 358. For example, in one embodiment, the nip 358 is about 1.2 to about 2.0 times the thickness of the continuous mass of dough 902 (e.g., bread tube) when flattened, which is approximately the thickness 384 of the first portion of dough 304 plus the thickness 386 of the second portion of dough 306. In other words, in one embodiment the nip 358 is about 1.2 to about 2.0 times the thickness of the continuous mass of dough 902 when there is substantially no intervening gap 380 between the first portion of dough 304 and the second portion of dough 306. In one embodiment, the nip 358 is about 1.5 times the thickness of the continuous mass of dough 902 when flattened.

In one embodiment, the connective faces 382a,b between the first portion of dough 304 and the second portion of dough 306 are equal in length to the distance between the first roller 316 and the second roller 318 minus the thickness of the continuous mass of dough 902 when flattened. Accordingly, in some embodiments, the connective faces 382a,b are short in the sense that the length of the connective faces 382a,b are only about 0.2 to about 1 times the thickness of the continuous mass of dough 902 when flattened. In one embodiment, the connective faces 382a,b are only about 0.5 times the thickness of the continuous mass of dough 902 when flattened.

Although the invention has been generally discussed with respect to a continuous, steady state process, the invention can also experience start-up states, for example, after maintenance. During a start-up state, as a bread-tube first undergoes a splitting step 210a, the leading end of the bread tube will need to be split, which can be more complicated than continued splitting after the leading end has already been split.

In embodiments that use vacuum rollers with a mechanical assist (e.g., ultrasonic blades positioned at or slightly downstream of a nip) to split a bread tube, splitting the leading end of the bread tube does not require special treatment.

Similarly, in embodiments that use vacuum rollers alone to split a bread tube, splitting the leading end of the bread tube does not necessarily require special treatment (see, e.g., FIG. 3E). However, in some embodiments, the leading end is removed before it reaches the vacuum rollers, which makes splitting easier. For example, in one embodiment, the bread tube is cut along a cross-sectional plane that is substantially perpendicular to the surface of a conveyor for the bread tube. This exposes a cavity in the interior of the bread tube before it reaches the vacuum rollers.

When desirable, the leading end of a bread tube can be removed in a variety of ways, for example, by cutting with mechanical cutting equipment or water jets. In some embodiments, removing the leading end with a water jet is more desirable than removing the leading end with mechanical cutting equipment because mechanical cutting equipment can seal the tube. For example, in some embodiments, when the cutting equipment slices through a cross-section of the bread tube to remove the leading end, the cutting equipment also crimps the bread tube, essentially creating a new leading end. Accordingly, it can be desirable to remove the leading end using a water jet cutter.

Although an embodiment of the invention has been described with the splitting step 210a being a separate step from a later trimming step 216a, in one embodiment, the splitting step 210a comprises a trimming step 216a. For example, longitudinal trimmers can be used to trim one continuous mass of dough into several strips of dough before a top portion of the dough is removed from a bottom portion of the dough. If this occurs, the top portion of dough will fall onto the bottom portion of dough as it is trimmed and both portions can be conveyed, for example, between vacuum rollers or vacuum conveyors. By exposing the strips to vacuum, the strips in the top portion of dough can be separated from the strips in the bottom portion of dough. Then, the strips can be further processed. For example, the strips in the top portion of dough can be conveyed to a top conveyor and the strips in the bottom portion of dough can be conveyed to a bottom conveyor.

With reference again to FIG. 2A, an optional filling step 212a is a fourth step in one embodiment of the invention. For example, the split dough can be filled with a filling. Although the filling step is shown as occurring before the takeaway conveying step, the filling step can occur before, during, or after the takeaway conveying step. Additionally, in some embodiments, a filling is added to the dough even though the dough is not split.

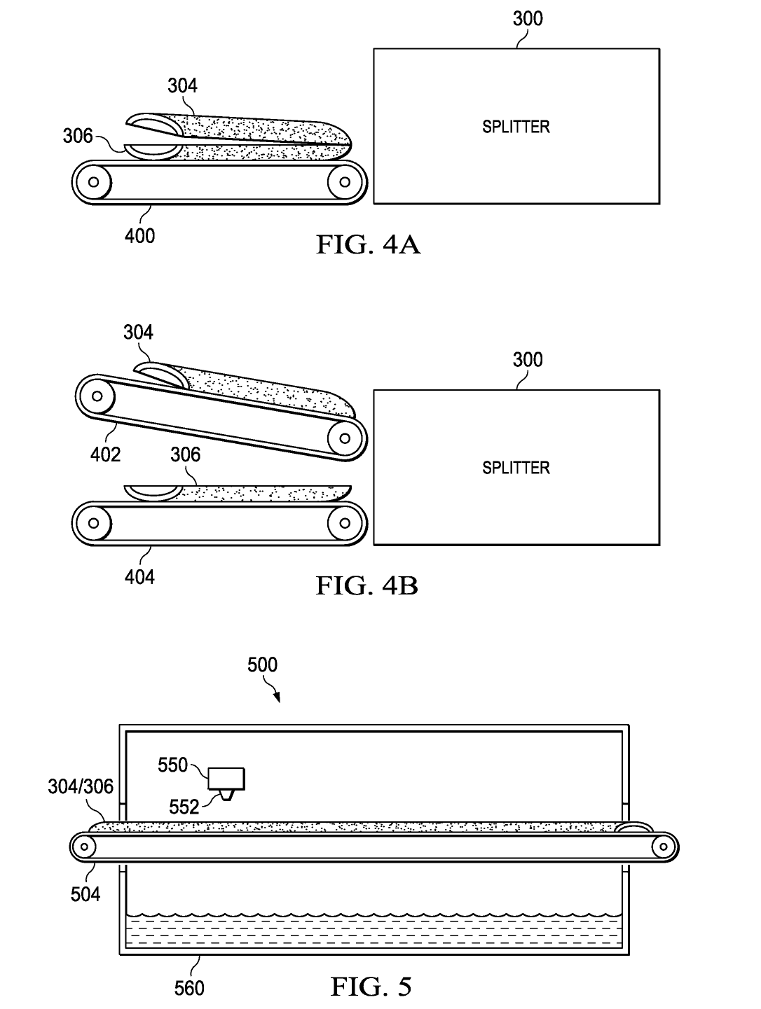

With reference again to FIG. 2A, a takeaway conveying step 213a is a fifth step in one embodiment of the invention. During the takeaway conveying step 213a, at least one takeaway conveyor (see, e.g., takeaway conveyors 400, 402, 404 in FIGS. 4A-4B) conveys at least one portion of dough away from the first and second roller 316,318 and/or cutting equipment 310. For example, the first roller 316 can convey a first portion of dough 304 to a first takeaway conveyor 402 and the second roller 318 can convey a second portion of dough 306 to a second takeaway conveyor 404.

In one embodiment, the first roller 316 and the second roller 318 comprise a top roller 316 and a bottom roller 318, the first portion of dough 304 and the second portion of dough 306 comprise a top portion of dough 304 and a bottom portion of dough 306, and the first takeaway conveyor 402 and the second takeaway conveyor 404 comprise a top takeaway conveyor 402 and a bottom takeaway conveyor 404. As shown in FIG. 3F, the top roller 316 conveys the top portion of dough 304 to the top takeaway conveyor 402 and the bottom roller 318 conveys the bottom portion of dough 306 to the bottom takeaway conveyor 404. The top takeaway conveyor 402 can be positioned for example, above the nip 358 between the first roller 316 and the second roller 318.

As shown in FIG. 3E, a first stationary manifold 360a in the first roller 316 (e.g., top roller) can be positioned to provide a vacuum downstream of a nip 358 between the first roller 316 and the second roller 318. This can help to convey the top portion of dough 304 to the top takeaway conveyor 402.

FIG. 3E also shows a second stationary manifold 360b in the second roller 318 (e.g., bottom roller). The manifold 360b is positioned to provide a vacuum upstream of a nip 358 between the first roller 316 and the second roller 318. This helps convey the bottom portion of dough 306 from a first conveyor (e.g., conveyor 910 in FIG. 3D) to a nip 358 between the first roller 316 and the second roller 318.

In some embodiments, for example, as shown in FIG. 3F, the invention comprises at least one scraper (e.g., at least one of scrapers 388a,b) to guide the continuous mass of dough 902 into a desired position (e.g. to or from the rollers 316, 318 or a conveyor 910, 400, 402, 404 as shown in FIGS. 3D and 4A-4B).

With reference again to FIG. 2A, drying step 218a is a sixth step. In the drying step 218a, the split and partially cooked continuous mass of dough 902 is dried. In one embodiment, a two-tier conveyor oven is used, with a first tier being used to dry the first portion of dough 304 and a second tier being used to dry the second portion of dough 306. In some embodiments, drying energy is focused at an inner crumb surface 390 of a split and partially cooked dough 302, which can be, for example, in the form of split bread tubes 302 as shown in FIG. 3G. Focusing the drying energy can be useful because, in some embodiments, the inner crumb surface 390 is wetter than the outer crust surface 392 of the partially cooked dough 302. Accordingly, the drying step 218a can serve to equalize the moisture on the inner crumb surface 390 and the outer crust surface 392. Although, the drying step can also be used to reduce total product moisture, for example, when a sandwich filling is used.

Various mechanisms can be used to achieve drying 218a, although some mechanisms may be more advantageous than others. For example, in one embodiment, the drying step 218a is selected from the group consisting of infrared drying and impingement. An example of directed impingement is blowing hot air or superheated steam against the continuous mass of dough 902. In one embodiment, drying is accomplished using directed infrared drying or directed hot air impingement. In one embodiment, the infrared waves or hot air is directed at the wetter side of the dough.

Seventh, with reference again to FIG. 2A, the partially cooked dough 302 is trimmed in a trimming step 216a. In one embodiment, the trimming step 216a comprises both longitudinal and lateral trimming. Although in some embodiments the trimming step 216a can occur immediately after the splitting step 210a, in other embodiments an optional filling step 212a and/or drying step 218a can be used. If an optional filling step 212a is used, a filling can be added to the first portion of dough 304 and/or the second portion of dough 306. For example, a filling can be added on top of a bottom portion of dough 306.

Regardless of whether a filing step 212a is used, it can be useful to bring together the first and second portions 304, 306 of the partially cooked dough 302 before longitudinal and/or lateral trimming during the trimming step 216a.

In one example of longitudinal trimming, after the partially cooked dough 302 is removed from a two-tier conveyor oven in the drying step 218a, the first (e.g., top) and second (e.g., bottom) portions of dough 304, 306 are brought together and longitudinally trimmed into narrower strips (e.g., strips 906a,b,c,d,e,f in FIG. 9A) about 2 inches wide. In one embodiment, this longitudinal trimming is accomplished using a stationary longitudinal trimmer 912 comprising stationary water jet nozzles 914a,b,c,d,e. To reduce water uptake in the dough 902, the stationary water jet nozzles 914a,b,c,d,e can be positioned over a narrow gap 922 (e.g., about ⅛ inch) between two endless conveyors (e.g., conveyors 910a,b). Accordingly, as the split and partially cooked dough (e.g., continuous mass of dough 902) is conveyed over the two conveyors 910a,b in series, the dough passes over the narrow gap 922 and under the stationary water jet nozzles 914a,b,c,d,e which trim the dough into narrower strips 906a,b,c,d,e,f.

In one embodiment, after the partially cooked dough 302 is trimmed by the stationary longitudinal trimmer 912, it is trimmed by a lateral trimmer (e.g., trimmer 702 in FIG. 7). For example, the continuous, longitudinally trimmed strips of partially cooked dough (e.g., strips 906a,b,c,d,e,f in FIG. 9A) with discrete widths can be laterally trimmed into discrete pieces (e.g., chips 706 in FIG. 7) with discrete lengths (e.g., 2 inches). In other words, the strips 906a,b,c,d,e,f are cut so that they are no longer integral with the continuous mass of dough 902 that was provided (e.g., during the cutting step 206a in FIG. 2A). In one embodiment as illustrated, for example, in FIGS. 5 and 7, lateral trimming is accomplished by conveying the partially cooked dough 302 (or some portion thereof 304, 306, 602, 604, 606) along a mesh conveyor belt 504 in a longitudinal direction while moving water jet nozzles 552, and accordingly water jets, across the width of the mesh conveyor belt 504 in a lateral direction. A lateral trimmer (see, e.g., trimmer 702 in FIG. 7 and moving water jet nozzle 552 in FIG. 5) can have a translational velocity that is several times the translational velocity of the conveyor belt 504. In conjunction with the mesh conveyor belt 504, the relatively high speed of the lateral trimmer 702 can help reduce water uptake in the partially cooked dough 302 while it is trimmed into discrete pieces 706.

In some embodiments, lateral and/or longitudinal trimming is performed using a mechanical cutter such as a rotary blade (e.g., rotary blade 310 in FIG. 3C) or other type of blade that is appropriately oriented and travels longitudinally and/or laterally as appropriate. For example, if a first portion of dough 304 and second portion of dough 306 do not comprise a filling and are sufficiently dry, it can be desirable to use rotary blades or band saws to perform lateral trimming rather than using water jets. Additionally, while an embodiment of the invention has been described with the trimming step 216a occurring at a certain time relative to other steps in a process, the trimming step 216a, can take place at other times during the process. For example, in one embodiment, a trimming step 216a occurs after dough exits an oven for making continuous bread tubes, but before a first portion of the dough is separated from a second portion of the dough. For example, if a bread tube is longitudinally trimmed into strips before it is split into a top portion and a bottom portion, the top portion of the dough will fall onto the bottom portion of the dough when trimmed, resulting in a top layer and a bottom layer of strips. It can then be desirable to separate the top layer of strips from the bottom layer of strips, for example, by using vacuum rollers or vacuum conveyors.

Returning to FIG. 2A, a further processing step 219a is an eighth step. In the further processing step 219a, the discrete pieces 706 of partially cooked dough 302 can be further processed into pita chips in at least one further processing step. In some embodiments, the at least one further processing step is continuous. As examples, the at least one further processing step 219a can comprise at least one step selected from the group consisting of a drying step 218a, a cooling step 220a, and a finish cooking step 222a. In some embodiments, formulation and process adjustments are made to provide the finished pita chips 706 with the desired characteristics, for example, organoleptic properties, nutritional properties, or health benefits.

Among other advantages, the invention described herein can replace much lengthier pita making processes, eliminate considerable manual handling, minimize product waste, reduce production costs, and enhance product consistency.

### A. Sheeting, Proofing, and Cutting Steps

Table 1 below shows an example of the dough formula used to produce a pita chip in one embodiment.

TABLE 1

| Ingredient | Weight Percentage |
|---|---|
| Enriched Wheat Flour | 30-62% |
| Whole Wheat Flour | 0-31% |
| White Whole Wheat Flour | 1-5% |
| Sugar | 1-5% |
| Salt | 0-5% |
| Oat Fiber | 0-5% |
| Yeast | 1-5% |
| Actual water | 31-34% |

Ingredients, such as those listed in Table 1, are first mixed by methods known in the art to form sheetable dough prior to the sheeting step 202.

One embodiments of Applicants' process 200 begins with a sheeting step 202. As used herein, sheeting 202 means forming a continuous sheet of bread dough. In one embodiment, the sheeting step 202 is a low-stress sheeting operation. A sheeter means any mechanical means of forming a continuous sheet of dough. In one embodiment, the sheeter involves two or more sheeter roller pairs such that the thickness of the sheet is gradually reduced, thereby limiting the work imparted to the dough by the sheeters. In one embodiment, sheeter forms the dough sheet to a final thickness of about 0.2 to 0.5 centimeter (cm).

In one embodiment, a continuous conveyor system transports the continuous dough sheet to the proofing step 204. A proofer is food processing equipment that allows the dough to rise in a warm, humid environment for a period of time before further processing. A proofer box is a chamber that is humidity- and temperature-controlled, for example, at about 50% relative humidity and about 32° C. As used herein, proofing 204 means subjecting the continuous sheet of pita dough to proofer equipment or a proofer box as described. Proofing 204 relaxes the stress in the dough and allows the yeast to work. In one embodiment, the proofing time varies from zero to 20 minutes, depending upon the amount of flour in the dough, the amount of yeast in the dough, and the preferred texture of the end product. A softer textured product, for example, typically needs a longer proofing time than a harder textured product.

After the proofing step 204, a conveyor transports continuous dough sheets through a cutter to a cutting step 206. In an alternative embodiment, the cutting step 206 occurs prior to the proofing step 204. A continuous cutter cuts 206 the continuous dough sheet into longitudinal flat strips or, stated differently, two or more narrower continuous sheets. Some embodiments of the cutter also make shapes other than longitudinal flat strips, such as continuous longitudinal hexagonal shapes and longitudinal round shapes. In some embodiments, the longitudinal flat strips are slightly spread apart to prevent them from sticking to each other. In one embodiment, the dough strip width is from about 20 to from 26 cm. Relatively wider strips of dough are used to minimize breakage and loss in some embodiments because it is easier to split wider strips. Another advantage of using wider strips of dough is that they have a decreased tendency to stick to each other, which allows Applicants' process 200 to skip the optional spreading step. Because there is no need to provide for gaps in such embodiments, the process 200 is capable of making the strips as wide as the conveyor width divided by the number of strips desired. In embodiments that have narrower strips (e.g., less than about 3 cm), the strips are optionally spread apart slightly to prevent re-adhesion.

### B. Cooking Step

At the cooking step 208, the dough strips are formed into continuous bread loaves 302 (see FIG. 3A) in a cooking oven 350 (see FIG. 3B). The cooking oven 350 is any type of oven capable of baking dough products at sufficiently high temperatures. In one embodiment, the cooking oven 350 is a two-zoned oven set at temperatures in the range of about 300° C. and about 600° C. In one embodiment, the two zones are set at about 595° C. and 575° C. for zones 1 and 2, respectively. In some embodiments, the dwell time through the oven ranges between about 6 and 60 seconds, depending on product thickness and heat intensity.

During the cooking step 208, the dough strips puff up and form a cavity in the center of each strip (see FIG. 3A). This results in tubes of bread 302. “Pita bread tube,” “pita tube,” “bread tube,” “unsplit tube,” or any of their plural forms (collectively 302) are used interchangeably to refer to the partially cooked continuous bread product exiting the cooking step 208 that has a cavity in the center of the bread.

Upon exiting the cooking oven 350 after the cooking step 208, the bread tubes 302 are only partially cooked, and have about 32% water by weight in one embodiment. Further, the bread tubes 302 are still tacky in the middle and pliable, having a higher moisture level in the interior of each loaf as compared to the exterior of the loaf. In some embodiments, the bread tubes 302 maintain their tube-like structure and the top 304 and bottom 306 layers do not re-adhere together.

### C. Optional Splitting Step

1. Split-Tubes

The pita tubes 302 exiting the cooking oven 350 may be processed in various ways. In one embodiment, the splitting step 210 (FIG. 2) uses a splitter 300 (see FIGS. 3A, 3B, and 3C) to split the continuous bread tubes 302. As used herein, a splitter 300 means any cutting equipment operable to split the continuous bread tube 302 longitudinally. Longitudinally means along the length (e.g., longest dimension) of an object, for example, along the length of the continuous bread tube 302. Alternatively, Applicants' process 200 bypasses the optional longitudinal splitting step 210, and the continuous, unsplit tubes 302 proceed directly to subsequent steps.

In some embodiments, the continuous pita tubes 302 are split 210 longitudinally with the aid of a vacuum apparatus. Such vacuum apparatus includes any vacuum equipment capable of transporting the continuous pita tubes 302 through the splitter 300 while maintaining (holding by way of the vacuum) the tubular structure. Some examples of a suitable vacuum apparatus include vacuum conveyor(s) 308, 312, 314 (see, e.g., FIGS. 3A and 3B) or vacuum rollers 316, 318 (see, e.g., FIG. 3C). The bread tube 302 is still pliable upon exiting the cooking oven 350. In some embodiments, the bread tube 302 are kept taut as the upper vacuum conveyor 308 pulls on the top side 304 and the lower vacuum conveyor 312 pulls on the bottom side 306. The bread tube 302, because it is pliable, becomes more uniformly shaped as it is being pulled evenly by the two vacuum conveyors 308, 312. In various embodiments, the vacuum conveyors are capable of being modified to accommodate any shape of pita bread, including round or hexagonal shapes.

In some embodiments, as seen in FIG. 3A, bread tubes 302 are held in place by a vacuum conveyor system comprising two vacuum conveyors 308, 312. The upper vacuum conveyor 308 is coupled to the top side 304 of the bread tube and the lower vacuum conveyor 312 is coupled to the bottom side 306 of the bread tubes 302. The upper vacuum conveyor 308 is registered with lower vacuum conveyor 312 to synchronize their movement to ensure that the bread tubes 302 are not subjected to any unwanted longitudinal shearing action. As used herein, registered means that two vacuum conveyors 308, 312 are moving at the substantially same velocity, in substantially the same direction, at substantially the same time. While FIG. 3B shows the vacuum conveyor 314 as ending shortly before the band saw 310, this is merely for illustrative purposes to show the bread tube 302 being split. In various embodiments, the vacuum conveyors 308, 312 are used any time beginning from the point where the bread tubes 302 are removed from the heat after cooking step 208 (FIG. 2) until the vacuum conveyors 308, 312 are no longer needed.

In an alternative embodiment, a single vacuum conveyor 314 maintains the walls of the tubes 302 taut by lifting the top section 304 with only the upper conveyor 314 (see FIG. 3B). In another embodiment, the bread tubes 302 maintain their hollow structures. In such embodiments, vacuum rollers 316, 318 are used to hold the bread tubes 302 just near the splitting mechanism 310 (see FIG. 3C) instead of full-length vacuum conveyors 308, 312. The upper vacuum roller 316 is registered with lower vacuum roller 318 in such embodiments.

One of the advantages of using a single vacuum conveyor 314, vacuum conveyors 308, 312, or vacuum rollers 316, 318—in addition to maintaining the tube structure—is that the tubes 302 are capable of being uniformly cut and thus minimize product wastage.

In one embodiment, as illustrated in FIG. 3A, the two-layered vacuum conveyors 308, 312 are spaced to obtain a slightly flattened, substantially rectangular bread tube 302. The height of the space between the upper vacuum conveyor 308 and the lower vacuum conveyor 312 defines the height of the bread tube. Placing the splitting mechanism 310 midway between the vacuum conveyors 308, 312 will split the bread tube down its vertical center. This results in top half 304 and bottom half 306 being nearly identical in size and shape, which leads to uniform final chip products. In an alternative embodiment, FIG. 3B, the vacuum rollers 316, 318 are spaced so that the bread tube 302 is squeezed down to a substantially rectangular cross-sectional shape near the splitting mechanism 310. In another embodiment, the single vacuum conveyor 314 is placed and oriented so that the bread tubes 302 are flattened to a substantially rectangular cross-sectional shape near the splitting mechanism 310. Converging the vacuum conveyors 308, 312 or the vacuum rollers 316, 318 at the splitting mechanism 310 helps to further achieve a more uniform split product.

In one embodiment, as seen in FIGS. 3A, the splitting mechanism 310 is horizontal rotary blades. The horizontal rotary blades are located on both sides of the continuous bread tube 302. The rotary blades rotate about an axis perpendicular to the horizontal plane of the bread tube. In one embodiment, two bread tubes 302 are placed on either side of the horizontal rotary blade to simultaneously split more than one bread tube 302 at a time. When rotary blades are used, they are optionally assisted by ultrasonic or other suitable technology to prevent residue from building up on the blades. In one embodiment, the splitter 300 is located towards the end of the vacuum conveyors 308, 312 where the bread tube 302 exits the splitter 300. In the embodiments where rotary blades are used, the leading end of the bread tubes 302 (i.e., the bread end formed at the very beginning of the continuous process) are trimmed to allow the bread tubes 302 to open up into two halves 304, 306.

In another embodiment shown in FIG. 3B, the splitting mechanism 310 is a scallop-edged band saw. The band saw is located at the exit end of the vacuum conveyors 308, 312, and splits the bread tube 302 into top half 304 and bottom half 306. The splitting mechanism 310 cuts along the vertical center, and splits the bread tube 302 into top half 304 and bottom half 306. In some embodiments, the band saw is assisted by suitable knife technology to prevent residue build-up. In other embodiments, the splitting mechanism 310 is any suitable mechanism to continuously split 210 the continuous bread tube 302. One advantage of some embodiments of the disclosed process is that the continuous bread tubes 302 produced have less wrinkled surface, which results in further reduction of product wastage during the optional splitting step.

Once the pita bread tube 302 is split into two halves 304, 306 in the splitting step 210, they are transferred to the subsequent steps in at least two different ways. In one embodiment, as illustrated in FIG. 4A, the top half 304 is released from the top vacuum conveyor 308, thereby allowing the top half 304 to fall on to the bottom half 306, with both halves 304, 306 thereafter resting on single-tiered takeaway conveyor 400. The two halves 304, 306 are then carried away together. In another embodiment, as illustrated in FIGS. 3C and 4B, the two halves 304, 306 are transported using a two-tiered takeaway conveyor 402, 404. The two-tiered takeaway conveyor has a top takeaway conveyor 402 and a bottom takeaway conveyor 404. The top half 304 and bottom half 306 of the bread tube are kept separate and transported by top takeaway conveyor 402 and bottom takeaway conveyor 404, respectively. The single-tiered 400 or two-tiered 402, 404 takeaway conveyors are belt conveyors, vacuum conveyors, or a combination of the two in various embodiments.

One of the advantages of splitting 210 the bread tubes 302 is that it exposes the inner or crumb side to make it look like a manually split, artisan pita loaf. Crumb exposure adds to the consumer's eating experience by providing the unique pita crumb texture. Thus, one of the benefits of using a two-tiered takeaway conveyor 402, 404 is that it helps to maintain the crumb-side texture by transporting the top half 304 and bottom half 306 of the bread tube separately.

In some embodiments, the split tubes 304, 306 are optionally sprayed on the crumb sides with anti-adhesive liquid that inhibit re-adhesion. In at least one embodiment, the anti-adhesive liquid is also a flavor-enhancing agent, such as oil. The split tubes 304, 306 maintain the crumb texture and do not re-adhere to one another even when they are transported using a single-tiered takeaway conveyor 400.

One embodiment of the invention will now be described with reference to FIGS. 3C-3E, which depict embodiments of an apparatus for splitting a continuous mass of dough 902 moving in a longitudinal direction 908 along a conveyor 910. The continuous mass of dough 902 is split longitudinally (e.g., along or in the longitudinal direction 908) to form a first portion of dough 304 and a second portion of dough 306. The apparatus comprises a first roller 316, a second roller 318 and at least one source of vacuum 320.

In one embodiment, as shown in FIGS. 3D and 3E, the first roller 316 and the second roller 318 are spaced apart a distance 322 so that the continuous mass of dough 902 can pass between the first roller and the second roller while the first portion 304 is pulled in a first direction 324 by the first roller 316 and while the second portion 306 is pulled in a second direction 326 by the second roller 318. In one embodiment, the first roller 316 is positioned above the second roller 318, although other arrangements (e.g., adjacent, side-by-side, etc.) are also possible. Although the diameter of the first roller 316 and the second roller 318 can vary, in one embodiment, the first roller and the second roller have the same diameter and the diameter is about 4 inches to about 24 inches. In another embodiment, the diameter of the first roller and the second roller is about 12 inches. For some embodiments, there is essentially no limit on the upper size of the diameter for the roller apart from practical considerations, for example, space, cost or manufacturing constraints.

As shown in FIG. 3E, the distance 322 between the first roller 316 and the second roller 318 is large enough for the continuous mass of dough 902 to pass between the first roller 316 and the second roller 318. Additionally, in one embodiment, the distance 322 between the first roller 316 and the second roller 318 is small enough that when a continuous mass of dough 902 passes between the first roller 316 and the second roller 318, the first portion of dough 304 will contact the first roller 316 and the second portion of dough 306 will contact the second roller 318.

In one embodiment, the first roller 316 applies a first force to move the first portion of dough 304 in a first direction 324 and the second roller 318 applies a second force to move the second portion of dough 306 in a second direction 326. The first direction 324 and the second direction 326 can be completely opposite. Alternatively, the first direction 324 and the second direction 326 can be partially opposite. In other words, when the first direction 324 and second direction 326 are resolved into components, a component of the first direction 324 is opposite to a component of the second direction 326.

As shown in FIGS. 3D and 3E, the first roller 316 comprises a first surface 336 and a first interior 332, and the first surface 336 comprises a first set of apertures 340 in fluid communication with the first interior 332. Similarly, the second roller 318 comprises a second surface 338 and a second interior 334, and the second surface 338 comprises a second set of apertures 342 in fluid communication with the second interior 334.

In some embodiments, a roller 316, 318 is a two piece design comprising a drum with a screen that is wrapped around the drum. The drum comprises larger apertures and a larger percent open area and the screen comprises smaller apertures and a smaller percent open area. As a result of larger apertures and/or larger distance between the apertures, the drum comprises a relatively higher percent open surface area on the rolling surface 336, 338 (e.g., the curved surface 336, 338 excluding the flat ends shown in FIG. 3D) of the roller 316, 318. When applying the screen to the drum, smaller apertures and/or a smaller distance between apertures result in a relatively lower percent open area on the rolling surface of the roller. In some embodiments, no screen is used and the drum itself has relatively smaller apertures and a relatively smaller percent open area. The amount of percent open area can be controlled, for example, by changing the distance between apertures, the number of apertures, and/or the size of apertures.

In one embodiment, the effective open area of the roller (e.g., drum by itself or combined drum and screen, if a screen is used) is anywhere from 20% to 60% of the total surface area of the roller excluding the ends. In some embodiments, the percentage open area may vary from 0% to 70% on the surface of the roller depending on the level of vacuum needed. In some embodiments, the level of vacuum needed varies across the surface of the roller, depending, for example, on the location and/or number of dough strips that contact the roller.

Although the sizes of the apertures can vary, in one embodiment, the first set of apertures 340 and the second set of apertures 342 are about the same size and provide an open surface area of about 60% to about 90% of the total surface area of the rolling surface 336, 338 of each roller 316, 318. The shape of the apertures can be any shape, for example, round or rectangular, with a dimension across the aperture (e.g., diameter, width, and/or length, as applicable) ranging from about ⅜ of an inch to about 2 inches.

In one embodiment, the surface 336, 338 of one or a plurality of rollers 316, 318 are covered with a screen to prevent the bread from being pulled inside the vacuum area. The screen is made of metal, although other materials can also be used. The screen has apertures with a diameter ranging from about 0.05 to about 0.5 inches. In one embodiment, the apertures have a diameter of about 0.1 inches. In some embodiments, a single screen has apertures with a plurality of diameter sizes. Since smaller screen aperture sizes are less likely to create indentions in the bread for a given vacuum force, smaller screen aperture sizes can be desirable. In some embodiments, the size of the apertures in the screen and/or roller drum, as applicable, is chosen to be the maximum size that avoids indentions in the bread when the vacuum force is applied. In some embodiments, the screen is removably fixed to the surface 336, 338 of a roller 316, 318, and it can be easily replaced with another screen, for example, a screen with differently number, size, or location of apertures, if it is desirable to do so. For example, it may be desirable to change a screen aperture size if the dough and/or vacuum strength changes. Turning to FIG. 3D, least one source of vacuum 320 provides a first vacuum in the first interior 332 and a second vacuum in the second interior 334 of the first and second rollers 316, 318, respectively. A vacuum conduit 344 (e.g., a duct), can be used to connect the source of vacuum 320 to the first roller 316 and/or the second roller 318 and provide a vacuum within the first roller 316 and/or the second roller 318. As used herein, the presence of a vacuum inside a roller indicates that a pressure inside a roller is lower than a pressure outside the roller. For example, if the pressure outside the roller is at atmospheric pressure (e.g., a gauge pressure of 0 psig) the pressure inside the roller would be less than atmospheric pressure (e.g., a gauge pressure of less than 0 psig).

In one embodiment, for example, as shown in FIGS. 3D and 3E, the at least one source of vacuum 320 provides a pressure within the first interior 332 that is lower than a pressure of a first exterior 346 of the first roller 316. Similarly, in one embodiment, the at least one source of vacuum 320 provides a pressure within the second interior 334 that is lower than a pressure of a second exterior 348 of the second roller 318.

In one embodiment, the at least one source of vacuum 320 provides a first difference in pressure between the first exterior 346 and the first interior 332, and the difference in pressure is sufficient to provide a first force to secure the first portion of dough 304 to the first roller 316. Likewise, in one embodiment, the at least one source of vacuum 320 provides a second difference in pressure between the second exterior 348 and the second interior 334, and the difference in pressure is sufficient to provide a second force to secure the second portion of dough 306 to the second roller 318.

In one embodiment, the first difference in pressure and a rotation of the first roller 316 provides a first force that pulls the first portion of dough 304 in a first direction 324 away from the second portion of dough 306. Similarly, in one embodiment, the second difference in pressure and a rotation of the second roller 318 provides a second force that pulls the second portion of dough 306 in a second direction 326 away from the first portion of dough 304.

In some embodiments, for example, as shown in FIG. 3E, the first vacuum and the second vacuum are strong enough to split the continuous mass of dough 902 into the first portion 304 and the second portion 306. For example, as shown in FIG. 3E, a splitter 300 comprising cutting equipment 310 is not required to split the continuous mass of dough 902.

However, in some embodiments, as shown in FIGS. 3C, 3F, and 3G, the invention comprises cutting equipment 310 for splitting the continuous mass of dough 902 (e.g., bread tube 302) into the first portion 304 and the second portion 306 (see, e.g., the first and second portions shown in FIG. 3D). As illustrated in FIG. 3C, the first roller 316 and the second roller 318 pull the continuous mass of dough 902 apart while the cutting equipment 310 cuts the continuous mass of dough 902. In one embodiment, the cutting equipment 310 is selected from the group consisting of a stationary blade, a band saw, and a rotary blade. Additionally, in some embodiments, the cutting equipment 310 comprises an ultrasonic cutter.

Turning back to FIG. 3E, in one embodiment, a roller 316, 318 also comprises a blow-off conduit 394a,b. The blow-off conduit 394a,b can be used to provide pressurized gas (e.g., at a higher pressure than the pressure of the exterior of the roller, for example, greater than 0 psig). As the pressurized gas flows from the blow-off conduit 394a,b, through the apertures of the roller 316,318, and out to the exterior of the roller, the pressurized gas provides a force to clean the roller. For example, the pressurized gas can expel dough or debris from the apertures in the roller 316,318.

In another embodiment, the blow-off conduit 394a,b can be used to provide a vacuum to all or a portion of the roller drum that is not encompassed by the vacuum manifolds 360a,b. The level of vacuum provided could be the same as, greater than, or less than the level of vacuum provided by the manifolds. For example, it could be advantageous to intermittently provide a greater level of vacuum to the roller to remove dough or debris from the apertures in the roller 316,318.

In addition, if the conduit 394a,b is capable of fluid communication with the interior 332,334 of the roller 316,318 that is under vacuum, the conduit 394a,b can be used to provide an additional source of vacuum. For example, the conduit 394a,b could be used to provide a stronger vacuum inside the vacuum manifolds 360a,b.

Although the invention has been described using a blow-off conduit 394a,b to clean and/or unplug the apertures in a roller 316,318, the roller 316,318 can also be cleaned by contact with a brush or an engaging pin roller. In some embodiments, a portion of the roller 316,318 that is not in contact with the dough is continuously cleaned. As the roller rotates, the portion of the dough that is being cleaned can continuously change. For example, the location of the cleaning apparatus (e.g., brush, blow-off conduit, or engaging pin roller) relative to the surface of the roller can continuously change, even if the cleaning apparatus is substantially stationary because the roller is rotating.

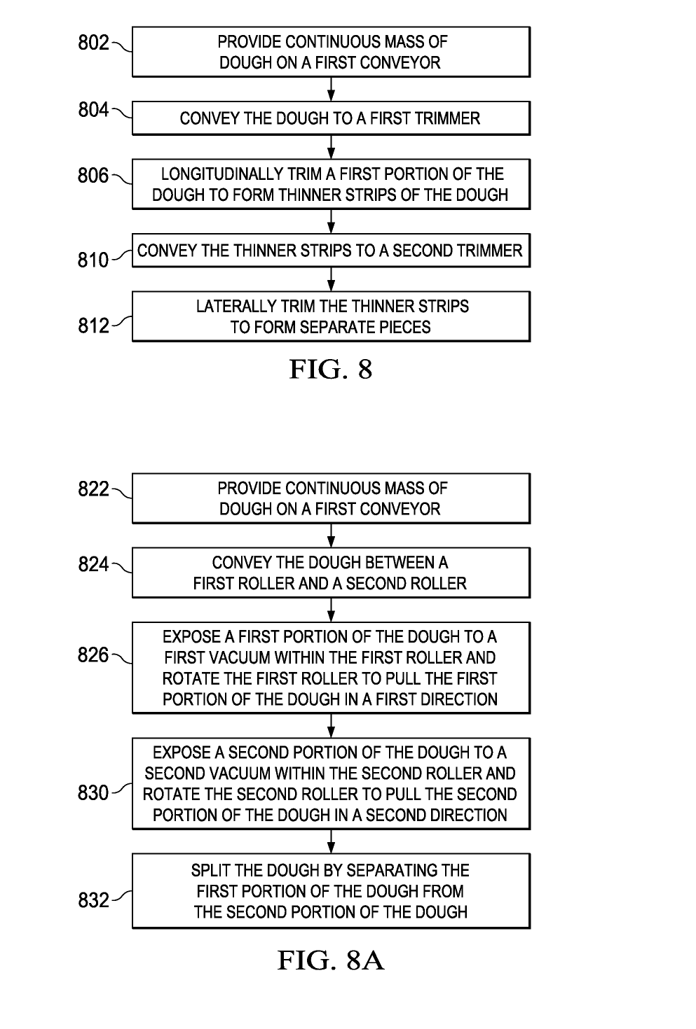

One embodiment of the invention will now be described with reference to FIG. 8A, which depicts a method for splitting a continuous mass of dough 902. First, in a providing step 822, a continuous mass of dough 902 is provided on a first conveyor 910. The continuous mass of dough 902 comprises a first portion of dough 304 and a second portion of dough 306. In some embodiments, the continuous mass of dough 902 provided on the first conveyor 910 can be a partially cooked dough, for example, a bread tube (e.g. bread tube 302 in FIGS. 3A and 3C) or some portion of a bread tube (e.g., top half 304 or bottom half 306 of bread tube 302 shown in FIG. 3A and 3B).

Second, in a first conveying step 824, a first conveyor 910 conveys the continuous mass of dough 902 in a direction of conveyance between a first roller 316 and a second roller 318. In some embodiments, the first conveyor 910 is an endless conveyor 910. As shown in FIG. 3D, the direction of conveyance is a longitudinal direction 908 along the length of the continuous mass of dough 902, which, in the illustration, is also along the first conveyor 910). The first roller 316 contacts the first portion of dough 304 and the second roller 318 contacts the second portion of dough 306.

Third, as shown for example in FIG. 3E, in a first exposing and rotating step 826, the first portion of dough 304 is exposed to a first vacuum within the first roller 316, and the first roller 316 is rotated, thereby pulling the first portion of dough 304 in a first direction 324. In one embodiment, the first direction 324 and the second direction 326 are not the same direction.

Fourth, in a second exposing and rotating step 830, the second portion of dough 306 is exposed to a second vacuum within the second roller 318, and the second roller 318 is rotated, thereby pulling the second portion of dough 306 in a second direction 326. As shown in FIG. 3E, the first roller 316 and the second roller 318 are rotated (e.g., in a first direction of rotation 328 and a second direction of rotation 330, respectively) so that they cooperate to pull the continuous mass of dough 902 in the direction of conveyance (e.g., longitudinal direction 908) and between the rollers. In one embodiment, the first roller 316 and the second roller 318 are rotated at substantially the same angular velocity. Additionally, in one embodiment, the first direction of rotation 328 and the second direction of rotation 330 are not the same direction (e.g., the first direction of rotation 328 is opposite the second direction of rotation 330).

Fifth, in a splitting step 832, the continuous mass of dough 902 is split by separating the first portion of dough 304 from the second portion of dough 306.

Although the steps of one embodiment of the invention have been described sequentially, the order can be modified so that a specific portion of dough can experience multiple steps (e.g., the first exposing and rotating step and the second exposing and rotating step) simultaneously. As another example, the splitting step can occur simultaneously with the exposing and rotating steps. Additionally, as shown in FIG. 3E, in some embodiments a cross-section 352 of the continuous mass of dough 902 experiences the exposing part of the second exposing and rotating step before the cross-section 352 experiences the exposing part of the first exposing and rotating step. For example, the cross-section 352 of the continuous mass of dough 902 can be exposed to the second vacuum before the cross section 352 is exposed to the first vacuum.

In some embodiments, the first roller 316 is rotated to convey the first portion of dough 304 at a first translational velocity and the second roller 318 is rotated to convey the second portion of dough 306 at a second translational velocity. In one embodiment, the first and second translational velocities are substantially equal. For example, in one embodiment, the first roller 316 has a first radius and is rotated at a first angular velocity, and the second roller 318 has a second radius and is rotated at a second angular velocity. Additionally, the first roller 316 comprises a first point of contact 354 with the first portion of dough 304 and the second roller 318 comprises a second point of contact 356 with the second portion of dough 306. The first and second angular velocities and the first and second radii can be selected so that the first point of contact 354 and the second point of contact 356 have substantially the same translational velocities. Although, in some embodiments, for example, when the first roller 316 and second roller 318 split the continuous mass of dough 902 without using cutting equipment 310, it can be useful for the translational velocity of the first point of contact 354 to be different than the translational velocity of the second point of contact 356.

In one embodiment, because the roller is round the force it applies to the dough has a radial or normal component and a tangential component. As the roller rotates, the force applied by the roller to a portion of the dough changes direction in Cartesian coordinates. For example, in one embodiment, when a first portion of dough 304 is located at a first position between the first roller 316 and the second roller 318, the tangential component of the first force applied by the first roller 316 to the first portion of dough 304 moves the first portion 304 in the direction of conveyance (e.g., longitudinal direction 908). Similarly, when a second portion of dough 306 is located at a second position between the first roller 316 and the second roller 318, the tangential component of the second force applied by the second roller 318 to the second portion of dough 306 moves the second portion 306 in the direction of conveyance (e.g., longitudinal direction 908). However, as the first roller 316 rotates, the first force applied by the first roller 316 to the first portion of dough 304 moves the dough is a first direction 324 (e.g., a direction that is different than the direction of conveyance). Similarly, as the second roller 318 rotates, the second force applied by the second roller 318 to the second portion of dough 306 moves the dough in a second direction 326 (e.g., a direction that is different than the direction of conveyance). In one embodiment, the first direction 324 and the second direction 326 are different (e.g., a component of the first direction 324 is opposite to a component of the second direction 326). In one embodiment, the first force and the second force are strong enough to split the first portion of dough 304 from the second portion of dough 306 by pulling the first portion of dough 304 and the second portion of dough 306 apart.

In one embodiment, the invention comprises the step of splitting a continuous mass of dough 902 by using cutting equipment 310.

In one embodiment, the invention comprises the step of vibrating a portion of the cutting equipment 310 (e.g. a blade) at high frequency while using the portion of the cutting equipment to split the continuous mass of dough 902. For example, in one embodiment vibrating at high frequency means vibrating at a frequency of about 20 to about 40 kHz. In one embodiment vibrating at high frequency means vibrating at a frequency of at least about 20 kHz.

In one embodiment, the continuous mass of dough 902 is a partially cooked dough.

In one embodiment, the continuous mass of dough 902 is a bread tube 302.

In one embodiment, the first portion of dough 304 is positioned opposite the second portion of dough 306.

In some embodiments, the method steps described in FIG. 8A occur as part of a method that includes one, some of, or all of the steps described with reference to FIGS. 2 and/or 2A. For example, in some embodiments, the providing step 822 for providing a continuous mass of dough 902 on a first conveyor 910 comprises several steps. First, in a sheeting step 202, bread dough is sheeted into a continuous dough sheet. Second, in a proofing step 204, the dough is proofed. Third, in a cutting step 206, the continuous dough sheet is cut longitudinally into a first set of continuous dough strips (e.g. using a trimmer like the first trimmer 912). Fourth, in a cooking step 208, the continuous dough strip from the first set of continuous dough strips is cooked in a continuous oven, thereby producing a continuous bread tube 302. In some embodiments, the continuous bread tube 302 comprises a cavity, a top surface 304, and a bottom surface 306. In some embodiments, the continuous bread tube 302 comprises the continuous mass of dough 902. In some embodiments, the continuous mass of dough 902 is the bread tube.

Fifth, as another example, some embodiments comprise a splitting step 210, in which the continuous bread tube 302 is split into portions (e.g. halves). In some embodiments, the splitting step 210 comprises splitting the continuous bread tube longitudinally into a first portion 304 (e.g., a top half) and a second portion 306 (e.g., a bottom half) using a splitting mechanism 310 assisted by a vacuum apparatus. In some embodiments, the continuous mass of dough 902 is a portion (e.g., top or bottom half) of the continuous bread tube, rather than the entire bread tube.

In some embodiments the splitting step 210 described with reference to FIG. 2 comprises the first exposing and rotating step 826, the second exposing and rotating step 830 and the splitting step 832 as described with reference to FIG. 8A.

Sixth, some embodiments comprise a filling step 212, in which the dough is filled with a filling.

Seventh, some embodiments comprise a curing step 214, in which the dough is cured. In some embodiments, the dough is partially cooked dough in the form of a continuous bread tube and the continuous bread tube is cured in less than about 60 seconds.

Eighth, some embodiments comprise a trimming step 216, for providing chip-sized pieces of dough.

Additionally, some embodiments comprise a drying step 218, a cooling step 220, and/or a finish cooking step 222.

Although various embodiments have been described with a plurality of steps, every step does not have to be present in every embodiment of the invention. For example, in some embodiments, only one step (e.g., sheeting 202) is used for providing a dough 822. In some embodiments, one or some of the steps for providing a continuous mass of dough 902 are optional. Additionally, in some embodiments, the order of the steps can be modified.

2. Unsplit-Tubes

In some embodiment, Applicants' process 200 bypasses the splitting step 210 and transports the unsplit bread tubes 302 to subsequent steps. One of the advantages of bypassing the splitting step is obviating the need to use vacuum conveyors 308, 312, 314, vacuum rollers 316, 318, or two-tiered takeaway conveyor 402, 404, thereby lowering operational costs.

Another advantage of unsplit tube 302 is the ability to make two-ply pita bread or chips with the look and feel of traditional, hand-made pita loaves. In one embodiment, the unsplit tubes 302 are optionally subjected to a pressing step using a knock-down roll press, nub roll press, or other device that presses the top and bottom layers together at specific points. The pressing step occurs either before or after the curing step 214 shown in FIG. 2.

In some embodiments, unsplit tubes 302 are optionally sprayed on the crumb side or the outer layer with anti-adhesive liquids. Furthermore, crumb exposure in unsplit tubes 302 is achieved by trimming 216 techniques (described below).

### D. Optional Filling Step

Consumers often dip pita chips in hummus or other dips. The filling flavors are chosen to imitate such experience in some embodiments. Alternatively, fruit- or vegetable-based fillings are chosen in other embodiments to enhance the nutritional value and attract health-conscious consumers. The fillings may be both of sweet or savory type. The choice of filling is determined by various factors, including flavor, mouthfeel, nutritional value, and water activity of the filling material.

One advantage of splitting 210 the bread tubes 302 is that it is capable of being filled easily (at the filling step 212) with various fillings between the top half 304 and bottom half 306 of the bread tubes. In such embodiments, once the filling material is placed between the top half 304 and bottom half 306 of the bread tubes, they are optionally pressed using a knock-down roll press, nub roll press, or other device that presses the top and bottom layers. The pressing step helps to ensure adhesion between the bread and the filling layers.

### E. Curing Step

The sequence of the optional splitting step 210, optional filling step 212, and the accelerated curing step 214—as well as the optional steps of pressing and spraying anti-adhesive liquid—are largely interchangeable. For example, in one embodiment, the bread tubes 302 proceed to the curing step 214 after the optional splitting step 210 and the optional filling step 212. In an alternative embodiment, the optional splitting step 210 and the optional filling step 212 occur after the curing step 214. Yet in another embodiment, the optional splitting step 210 occurs before the curing step 214, and the optional filling step 212 occurs after the curing step 214.

As used herein, curing 214 means a process by which the moisture content is generally equilibrated throughout the bread, although complete equilibrium is not required. The curing process can also facilitate starch retrogradation. In one embodiment, the desired uniform moisture level after curing ranges from about 10 to about 36%, and preferably about 28%. In some embodiments, if the unsplit pita tubes 302 or split tubes 304, 306 do not have a tackiness or re-adhesion issues, the curing step can optionally be bypassed.

In one embodiment, the curing step 214 occurs in a dryer or oven that uses electromagnetic frequency in the range of about 10 megahertz (MHz) to about 3 gigahertz (GHz). In the 10 to 100 MHz range, the apparatus is generally referred to as a radio frequency (RF) dryer. The so-called “inside out drying” process imparted by an RF dryer equilibrates the moisture level. In one embodiment, the continuous pita tubes 302 (or split tubes 304, 306) pass between electrodes having an alternating electric field which reverses its polarity at a rate of about 40 megahertz. When passing through an alternating electric field, polar molecules constantly realign themselves to face the opposite pole. At a frequency of 40 megahertz, this rapid movement causes the polar molecules of water to quickly heat, wherever moisture is present, throughout the entire thickness of the product. Nonpolar materials such as fat, oil, and dry ingredients do not react and, therefore, are not directly heated by RF energy. Thus, anti-adhesive liquids can optionally be applied before the curing step 214. In the case of unsplit pita bread tubes 302, the wettest area of the bread (i.e., inside the tube) will absorb more of the RF energy and will preferentially dry the inside. Further curing the bread tubes 302 after this equilibration process also brings down the total moisture of the bread tubes 302.

By using an RF dryer in one embodiment, the bread tubes 302 are uniformly and quickly cured 214. Curing in ambient conditions can last anywhere from 8 to 24 hours, depending on temperature and humidity. Applicants' accelerated RF curing 214 process reduces the curing dwell time significantly. In one embodiment, the temperature inside the RF dryer ranges from about 35° C. to about 150° C., and the dwell time ranges from about 5 to about 60 seconds and preferably between about 20 to about 30 seconds.

If both bread tube halves 304, 306 are transported using the single-tiered conveyor 400, as illustrated in FIG. 4A, then they enter a single-tiered RF dryer. If the halves 304, 306 are transported using the two-tiered takeaway conveyors 402, 404, as illustrated in FIG. 4B, they enter a two-tiered RF dryer.

In an alternative embodiment, the curing step 214 occurs in a two-tiered, high air-convection oven. As used herein high air-convection oven means a heating apparatus that has high heat transfer coefficient (e.g., from about 30 to about 1000 watts per square meter per degree Celsius or from about 60 to 600 watts per square meter per degree Celsius), for example, hot air impingement or infrared drying. In some embodiments the hot air impingement or infrared drying is directed to the wetter side of the dough. For example, when a bread tube is split in half, the top half can be wetter on the bottom side (e.g., crumb side) and the bottom half can be wetter on the top side (e.g., the crumb side). In some embodiments using infrared drying, the infrared source temperature ranges from about 250° C. to about 1100° C., which can be optimized for the distance from the source to the dough that is being dried. In some embodiments, the dough is cured for about 5 to about 60 seconds. A further alternative embodiment uses an infrared heat source at the curing step 214. In one embodiment, a two-tiered, double impingement oven is used. Because impingement is mostly a surface phenomenon, this embodiment of curing process work better with split tubes 304, 306. In such embodiments, the internal air temperature of the oven is in the range of about 60° C. to 400° C. An advantage of using a convection oven is the ability to enhance the flavor and coloring of the bread through, for example, browning.

### F. Trimming Step

As the split halves 304, 306 (or unsplit tube 302) exits the curing step 214, they proceed to the trimming step 216 where they are cut into chip-sized pieces using a trimmer. As used herein, trimmer means any mechanical means operable to continuously cut the bread tubes 302 or split tubes 304, 306 longitudinally and laterally. As used herein, lateral or laterally means in the general direction perpendicular to the longitudinal direction of the bread tube 302 or split tubes 304, 306. In various embodiments, the chip-sized pieces are cut to different final shape, such as square, rectangle, parallelogram, triangle, or other polygons.

There are various methods for continuously trimming 216 chip-sized pieces. For example, a cutting roller, a mechanical crushing, ultrasonic cutting, or shearing methods can be used. But these methods may pose problems in unsplit tubes 302. Cutting rollers or mechanical shears push the top layer 304 down onto the bottom layer 306 of the pita bread tube 302, thereby crimping the edges and welding the two layers together. This will seal off the crumb side (i.e., inner surface of the tube). As a result, the pita chips will pillow again once it enters the finish cooking stage, thereby causing increased breakage and differences to finished chip texture. Crumb exposure ensures that the pita chips do not puff up again in the finish cooking device. Therefore, maintaining the crumb exposure during the trimming 216 step can be beneficial. Further, if conventional cutting methods are used, the bread tubes 302 undergo extensive cooling to avoid crimped edges as a result of cutting. Cooling is highly energy- and space-inefficient. Moreover, transporting the bread tubes 302 to and from a cooler, requires cutting the bread tubes 302 at a certain length, which is undesirable for a continuous process.

In one embodiment, the trimmer is a continuous water jet cutting system 500 (see FIG. 5) that is capable of trimming 216 the bread tube 302 or halves 304, 306 without crimping the edges and ensuring excellent crumb exposure at about 93° C., i.e., without cooling. The water jet cutting system 500 comprises a pressure system that delivers water under pressure, a water collection system, and a motion system. The water jet cutting system 500 is capable of operating while in communication with a conveyor (e.g., a continuous conveyor on which dough or partially cooked dough, such as bread tubes are transported).

Referring to FIG. 5, the basic elements of the water jet cutting system 500 are seen. The motion system comprises a cutting head 550 and a permeable conveyor system 504 that is transporting a continuous mass of dough or partially cooked dough (e.g., the continuous halves 304, 306 depicted in FIG. 5 or a continuous loaf 302) through the trimming step 216. As used herein, the cutting head 550 comprises one or more movable water jet nozzles 552, optionally in an array, and the accompanying equipment that controls the movement of the cutting head 550. The water jet nozzles 552 are in communication with the pressure system by way of a high-pressure water line (not shown). The conveyor 504 is perforated or otherwise permeable to allow the water from the jet to drip to a catcher tank 560 below.

Continuous water jet cutting systems often utilize a jet nozzle that travels along a single linear, angled path across a product bed (e.g., the width of an array of bread tubes 302 or halves 304, 306 on the permeable conveyor system 504) at a precise speed resulting in a straight line cut across the continuous product strips transported on a conveyor. The jet nozzle starts at the leading edge of the product bed and reaches the lagging edge. In some embodiments, the jet nozzle returns to its starting position for the next cutting phase. During the return phase, the water flow must be stopped to prevent the continuous product strips from being cut at an angle to form irregularly shaped pieces. Conventional water jet systems use diverter or shut-off valves to stop the water flow through the jet nozzle. A diverter or shut-off valves must withstand enormous pressure, thus naturally are high-wear parts requiring frequent replacements.

In one embodiment, Applicants employ a water pressure of 13,000 psi (914 kilograms per square centimeter) in their pressure system. Conventional water jet cutting operation, on the other hand, utilizes water pressures from 30,000 psi to 60,000 psi. As used herein, low-pressure water jet cutting system means a water jet cutting system utilizing water pressures below that of a conventional water jet system, or below 30,000 psi. In one embodiment, the low-pressure water jet cutting system 500 utilizes pressures below 30,000 psi and preferably about 10,000 to about 25,000 psi. At the lower pressure, Applicants dramatically reduce the flow rate and the power requirements, rendering this technology more practical. The amount of wear on pressure components is also reduced with the use of lower operating pressures. Because the Applicants' process is continuous and therefore does not go through start-stop cycles, it reduces wear on the parts.

The processing speeds of Applicant's water jet cutting system 500 are very high compared to conventional water jet cutting systems. In one embodiment, the continuous pita strips pass through the water jet cutting system 500 at speeds of about 30 meters per minute with chip piece length of about 5 centimeters across a product bed of about 125 centimeters. Increased speeds allow for higher throughputs, thereby increasing productivity of the process as a whole.

When the cutting head 550 is on a path outside the conveyor width, the water stream travels directly to a catcher tank 560 below, shown in FIG. 5. The water collection system comprises the catcher tank 560 and a mist control system. The catcher tank 560 is large enough to cover the entire path of the cutting head 550. The impact of the water jet on the catcher tank 560 below the conveyor 504 causes a high amount of mist formation in the cutting chamber. The mist has a potential to settle back on the pita strips, thereby increasing its moisture content and decreasing the efficiency of the process (as the moisture will need to be removed again). As used herein, mist control system is a system that decreases or inhibits the mist formed by water jets from settling on the pita product during the trimming step 216. In one embodiment, Applicants use a combination of jet dissipaters, such as stainless steel mesh vanes, as a part of the mist control system. In another embodiment, Applicants force increased air flow (with a vacuum pump or blower) to significantly reduce mist formation.

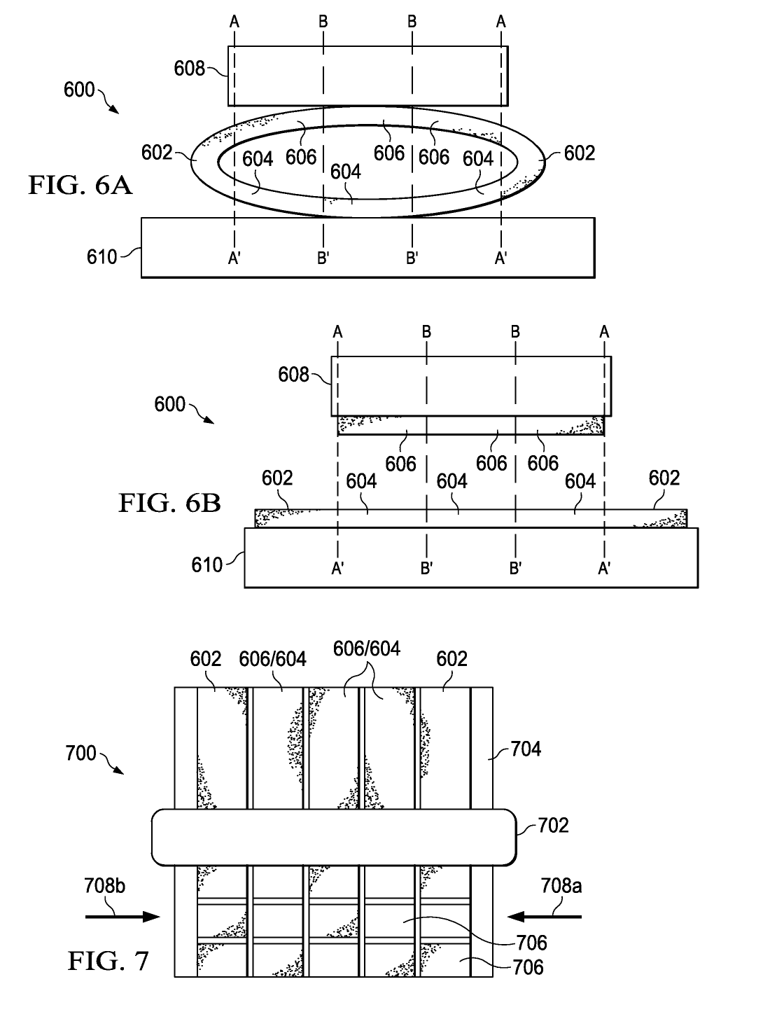

In some embodiments, the unsplit tube 302 is trimmed 216 to expose the crumb side, as shown in FIGS. 6A and 6B. The trimmer 600 has two or more cutting paths: A-A′ and B-B′. The A-A′ path cuts the bread tube 302 along the edges so that the edge piece 602, which is folded to about half the width (when viewed from the top) of the middle piece 604, 606. In other words, the distance between A and B is about double that of the distance between A and the edge of the bread 302. Depending on the width of the bread 302 and the desired size of the resultant chips, the distance between A and B and the number of B-B′ lines is adjusted accordingly. After it is trimmed 216, the edge pieces 602 become unfolded, and falls flat on the conveyor 610 (FIG. 6B). Thus, after trimming 216 the width of the edge pieces 602 and the middle pieces 604, 606 are substantially the same. The middle pieces 604 of the bottom layer are transported on the conveyor 610. The middle pieces 606 are transported using a vacuum conveyor 608.

Although trimmer 600 has been depicted as trimming an unsplit bread tube, in other embodiments, the trimmer 600 trims a continuous mass of dough 902 (see FIG. 9A), which, for example, can also be in the form of a sheet or in the form of half a bread tube. In one embodiment, the trimmer 600 trims both longitudinally and laterally across the product bed. In an alternative embodiment, the trimmer 600 trims only longitudinally, and a separate lateral trimmer 702 cuts across the product bed 704 to make chip-sized pieces 706 (FIG. 7). Both the trimmer 600 or the lateral trimmer 702 can be a water jet cutting system 500 or any other suitable cutting mechanism. The middle pieces 606 of the top layer are trimmed with the middle pieces 604 of the bottom layer in some embodiments; in other embodiments, they are transported to a separate trimmer.

One embodiment of the invention will now be described with reference to FIG. 8, which depicts a continuous method for making chips. First, in a providing step 802, a continuous mass of dough is provided on a first conveyor. In some embodiments, the continuous mass of dough is a partially cooked dough (e.g., a partially cooked tube of dough, such as a continuous bread tube). Second, in a first conveying step 804, a first conveyor conveys the continuous mass of dough to a first trimmer positioned over a gap between the first conveyor and a second conveyor. In some embodiments, the first trimmer comprises a liquid (e.g. water, oil, melted butter, flavored solution, etc.) jet nozzle. Although various liquids can be used for the liquid jet, the invention will be described using a water jet. Third, in a first trimming step, 806, the first trimmer longitudinally trims a first portion of the continuous mass of dough to form thinner strips of the continuous mass of dough. In some embodiments, the thinner strips are integral with the first portion. Fourth, in a second conveying step 810, the thinner strips are conveyed on a second conveyor (e.g., to a second trimmer). Fifth, in a second trimming step 812, the second trimmer laterally trims the thinner strips to form separate chip-sized pieces (e.g., chips, pita chips). In some embodiments, the first conveyor and the second conveyor are endless conveyors and convey the continuous mass of dough in a longitudinal direction. In some embodiments, the first trimmer is stationary.

In some embodiments, the method steps described in FIG. 8 occur as part of a method that includes one, some of, or all of the steps described with reference to FIG. 2. For example, in some embodiments, the trimming step 216 comprises the first conveying step 804, the first trimming step 806, the second conveying step 810, and the second trimming step 812. As another example, in some embodiments, the continuous mass of dough provided on the first conveyor can be a partially cooked dough, for example, a bread tube (e.g. bread tube 302 in FIGS. 3A and 3C) or some portion of a bread tube (e.g., top half 304 or bottom half 306 of bread tube 302 shown in FIG. 3A and 3B). In one embodiment, the providing step 802 for providing a continuous mass of dough on a first conveyor comprises several steps. First, in a sheeting step 202, bread dough is sheeted into a continuous dough sheet. Second, in a proofing step 204, the dough is proofed. Third, in a cutting step 206, the continuous dough sheet is cut longitudinally into a first set of continuous dough strips (e.g. using the first trimmer). Fourth, in a cooking step 208, the continuous dough strip from the first set of continuous dough strips is cooked in a continuous oven, thereby producing a continuous bread tube. In some embodiment, the continuous bread tube comprises a cavity, a top surface, and a bottom surface. In some embodiments, the continuous bread tube comprises the continuous mass of dough. In some embodiments, the continuous mass of dough is the bread tube. Fifth, in a splitting step 210, the continuous bread tube is split into portions (e.g. halves). In some embodiments, the splitting step 210 comprises splitting the continuous bread tube longitudinally into a top half and a bottom half using a splitting mechanism assisted by a vacuum apparatus. In some embodiments, the continuous mass of dough is a portion of the continuous bread tube. In some embodiments, the continuous mass of dough is the top half or the bottom half of the continuous bread tube. Sixth, in a filling step 212, the dough is filled with a filling. Seventh, in a curing step, the dough is cured. In some embodiments, the dough is partially cooked dough in the form of a continuous bread tube and the continuous bread tube is cured in less than about 60 seconds. Although, in other embodiments not all of these steps are used to provide a dough for trimming 216. For example, in some embodiments, only one step (e.g., sheeting 202) is used to provide a dough. In some embodiments, one or some of the steps for providing a dough for trimming are optional. Additionally, in some embodiments, the order of some steps is modified.

One embodiment of the invention will now be described with reference to FIG. 9A and FIG. 7. FIG. 9A depicts an illustrative apparatus for forming pita chips 706 using a first trimmer 912 positioned over a gap 922 between two conveyors (910a,b).

The apparatus forms pita chips from a continuous mass of dough 902. The continuous mass of dough comprises a first portion 904 and thinner strips (e.g., thinner strips 906a,b,c,d,e,f). The continuous mass of dough moves in a longitudinal direction 908 along conveyors (e.g., first conveyor 910a and second conveyor 910b). The first portion of the continuous mass of dough is cut in the longitudinal direction to form the thinner strips that are integral with the first portion. The thinner strips are cut in a lateral direction (e.g., lateral direction 708a or lateral direction 708b) to form the pita chips.

In the example shown, the apparatus comprises a first conveyor 910a, a second conveyor 910b, and a first trimmer 912. The first trimmer is stationary and the trimmer comprises a water jet nozzle (e.g., at least one of a plurality of water jet nozzles 914a,b,c,d,e).

FIG. 9A also depicts a second end 916 of the first conveyor and a first end 918 of the second conveyor that are adjacent and spaced apart a first distance 920 to form a gap 922. The first trimmer 912 is positioned above the gap 922. The first conveyor 910a, the second conveyor 910b, and the first trimmer 912 are positioned so that as the first conveyor and the second conveyor move the continuous mass of dough 902 in the longitudinal direction 908 and as the first trimmer 912 cuts the first portion 904 in the longitudinal direction: the first portion is supported by the first conveyor, and the thinner strips 906a,b,c,d,e,f are supported by the second conveyor. In some embodiments, the second end 916 of the first conveyor 910a comprises a first roller 932 (e.g. cylinder) and the first end 918 of the second conveyor 910b comprises a second roller 934 (e.g. cylinder). In some embodiments, a first conveyor belt 936 travels around the first roller 932 (e.g., along a portion of the circumference of the first roller) and a second conveyor belt 938 travels around the second roller 934 (e.g., along a portion of the circumference of the second roller). In some embodiments, the continuous mass of dough is conveyed on the first conveyer belt 936 (e.g. a solid conveyor belt) and the second conveyor belt 938 (e.g. a mesh conveyor belt). In some embodiments, the first roller 932 and the second roller 934 have a small diameter (e.g. about ½ inch to about 2 inches) so that a second distance 940 between the axes of rotation 942, 944 (e.g. center) of the rollers is small (e.g. about 9/16 to about 2.5 inches). As shown, the second distance is the sum of the first distance 920, a radius of the first roller, and a radius of the second roller. In some embodiments, it is useful for the second distance to be small because this is the distance between the tops of the cylinders and the maximum distance that the dough or partially cooked dough would need to span (if it were perfectly flat) in passing from the first conveyor to the second conveyor. Although, in practice the dough or partially cooked dough can bend and sag, so that it does not span the entire second distance. Nonetheless, maintaining a small second distance provides a useful point of reference for ensuring that the dough will not break when it passes over the gap 922 and simultaneously is cut (or trimmed) by trimmer 912. In one embodiment, the second distance is small enough that the dough does not stretch substantially in the longitudinal direction due to the force of gravity on the dough (e.g. the dough does not sag) as the dough passes from the first conveyor to the second conveyor. In one embodiment, the second distance is small enough that the dough does not substantially stretch longitudinally as the dough passes from the first conveyor to the second conveyor. Although one embodiment of the invention has been described using conveyors belts wrapped around rollers 932, 934, in some embodiments the conveyor belts are wrapped around one or more static nose bars. For example, the first roller 932 and a second roller 934 can be replaced by a first static nose bar and a second static nose bar, respectively. The static nose bar can have the same rounded shape as a roller, or it can have a more pointed shape. However, unlike the roller, the static nose bar is stationary and does not rotate. Rather a conveyor belt slides over the static nose bar.

Static nose bars can be useful because they can be provided with a small radius of curvature. For example, minimizing the radius of curvature for the nose bar (as with minimizing the radius of a roller) minimizes the distance from the gap 922 between two conveyors 910a,b (e.g., narrowest point between the conveyors) to the top surface 936 of the first conveyor 910a and/or the top surface of the second conveyor 910b. In other words, the depth of the gap 922 from the surface of the conveyors can be minimized. This can be useful to prevent the dough from sagging as it passes over the gap 922. Minimizing the depth of the gap 922 from the surface of the conveyors is also useful to reduce the distance from a water jet nozzle to the dough, which can be advantageous. However, it can also be advantageous to position a water jet nozzle above the surface of the conveyors to accommodate situations when the dough does not sag. Thus, if the dough does sags to some degree, the water jet nozzle can be further from the dough than desirable. By reducing the depth of the gap 922 from the surface of the conveyors, both sagging and the distance from the water jet nozzle to the dough can be reduced.

Using static nose bars in place of rollers can be useful to reduce the depth of the gap 922 relative to the surface of the conveyors. In one embodiment, the invention uses static nose bars with a radius of about ⅛ inch to about ½ inch so that the depth of the gap 922 from the surface of the conveyors is about ⅛ inch to about ½ inch. In one embodiment, the gap 922 is formed between a first conveyor and a second conveyor and each conveyor comprises a static nose bar adjacent to the gap 922 rather than a roller 932, 934.

Although FIG. 9A shows the second conveyor 910b as a mesh conveyor for use in lateral trimming, the second conveyor can also be an intermediate conveyor with a solid conveyor belt that passes over a static nose bar adjacent to the gap 922. Additionally, the second conveyor can convey the dough to a third conveyor that is a mesh conveyor (e.g., a mesh conveyor 910b shown in FIG. 9A) for lateral trimming.

As shown in the embodiment of FIG. 9A, a top 924 of the continuous mass of dough 902 is not constrained. For example, the apparatus does not comprise a pressure applicator to apply pressure to the continuous mass of dough and press the continuous mass of dough between the pressure applicator and the first conveyor or the second conveyor.

In some embodiments, the first distance 920 between the first conveyor 910a and the second conveyor 910b and/or the second distance 940 between the axes of rotation 942, 944 of the conveyors is small enough and the static force of friction between the first conveyor 910a and the first portion 904 (e.g., static coefficient of friction in combination with the normal force exerted by the weight of the dough) is large enough that the first portion resting on the first conveyor under the force of gravity does not substantially slip against the first conveyor when the first trimmer 912 cuts the first portion. In one embodiment, the first distance 920 between the first conveyor 910a and the second conveyor 910b and/or the second distance 940 between the axes of rotation 942, 944 of the conveyors is small enough and the static coefficient of friction between the second conveyor 910b and the thinner strips 906a,b,c,d,e,f is large enough that the thinner strips resting on the second conveyor under the force of gravity do not substantially slip against the second conveyor when the first trimmer 912 cuts the first portion 904.

In one embodiment, the apparatus further comprises a second trimmer 702. As shown in FIG. 7, the second trimmer cuts the thinner strips in a lateral direction (e.g., direction 708a or direction 708b) and is moveable. The second trimmer can comprise a plurality of water jet nozzles (e.g. at least two water jet nozzles like water jet nozzle 552 in FIG. 5) or a single water jet nozzle. In one embodiment, the second trimmer travels at 10 times the speed of the first conveyor. In one embodiment the second trimmer travels as fast as technically feasible, regardless of the speed of the conveyor belt, for example, to minimize water uptake in the dough. In one embodiment the second trimmer travels at about 100-1000 ft./min.

As shown in FIG. 9A, the first conveyor and the second conveyor travel at the same speed, and are endless conveyors. The first conveyor is a solid conveyor, and the second conveyor is a mesh conveyor. In one embodiment, the first conveyor and/or the second conveyor comprises a mesh conveyor belt. It is useful or even necessary to use a mesh conveyor for the second conveyor if the second trimmer uses a water jet to cut the continuous mass of dough as it is being conveyed on the second conveyor. For example, this helps prevent water from pooling next to the dough and being absorbed by the dough. The first conveyor can also be a mesh conveyor, although in some embodiments it offers less benefit than using a mesh second conveyor. For example, if the first trimmer is positioned over a gap between the first conveyor and the second conveyor, rather than above the first conveyor, less water will come into contact with the first conveyor. In one embodiment, the first conveyor and the second conveyor travel at approximately 10 to 100 ft./min. In one embodiment, the first conveyor and the second conveyor travel at approximately 30 ft./min.

As shown in FIG. 9A, the gap 922 between the first conveyor 910a and the second conveyor 910b is oriented in a lateral direction (e.g., parallel to direction 708a or direction 708b, and perpendicular to the longitudinal direction 908). Although in some embodiments the gap must have a lateral component to provide for multiple water jets 930a,b,c,d,e, the gap can also have a longitudinal component (e.g. a diagonal gap). As shown in FIG. 9A, the gap 922 is stationary. In some embodiments the gap is only slightly wider than a water jet (or the water jets 930a,b,c,d,e) used to trim the continuous mass of dough. In some embodiments, the water jet and/or gap is about 1/16″ (i.e., 1/16 inch) wide.

One embodiment of the invention will now be described with reference to FIG. 9B and FIG. 7. FIG. 9B depicts an illustrative apparatus for forming pita chips (e.g. chips 706). The apparatus comprises a support 926 positioned in a gap 922 between two conveyors (910a,b). A first trimmer 912 is positioned over the support 926.

The apparatus forms pita chips from a continuous mass of dough 902. The dough comprises a first portion 904 and thinner strips 906a,b,c,d,e,f that are thinner than the first portion. As the continuous mass of dough moves in a longitudinal direction (e.g. longitudinal direction 908) along conveyors (e.g. first conveyor 910a and second conveyor 910b), the first portion is cut in the longitudinal direction to form the thinner strips that are integral with the first portion. These thinner strips are cut in a lateral direction (e.g., lateral direction 708a or lateral direction 708b) to form the pita chips.

As shown in FIG. 9B, the apparatus comprises a first conveyor 910a, a second conveyor 910b, a first trimmer 912, and a support 926. The first trimmer 912 is stationary and comprises a water jet nozzle (e.g., at least one of a plurality of water jet nozzles 914a,b,c,d,e). The second end 916 of the first conveyor and a first end 918 of the second conveyor are adjacent and spaced apart a first distance 920 to form a gap 922. In some embodiments the first distance 920 is about 1/16 inch to about 1 inch. In some embodiments, the first distance is about ¼ inch.

In the embodiment shown in FIG. 9B, a support 926 is positioned in the gap 922 and the first trimmer 912 is positioned above the gap. The first conveyor 910a, the support 926, the second conveyor 910b, and the first trimmer 912 are positioned so that as the first and second conveyors move the continuous mass of dough 902 in the longitudinal direction 908 and as the first trimmer 912 cuts the first portion 904 in the longitudinal direction: the first portion 904 is supported by the first conveyor 910a and the support 926, and the thinner strips 906a,b,c,d,e,f are supported by the support 926 and the second conveyor 910b. In one embodiment, both the first trimmer 912 and the support 926 are stationary and the first trimmer is positioned above the support. As shown for the embodiment of FIG. 9B, the support 926 comprises an aperture (or plurality of apertures 928a,b,c,d,e) that receives a water jet (or plurality of water jets 930a,b,c,d,e) from the trimmer 912, and the support 926 blocks splashing or mist created when the water jet contacts an interior of the support.

In one embodiment of the invention, the first trimmer and the second trimmer use a continuous low-pressure water jet cutting system (e.g., the low-pressure water jet cutting system 500 shown in FIG. 5).

In one embodiment, the continuous mass of dough 902 is partially cooked dough in the form of a bread tube (e.g. bread tube 302 in FIGS. 3A and 3C). In one embodiment, the continuous mass of dough is a portion of a bread tube.

In one embodiment, the pita chips (e.g., chips 706 in FIG. 7) are about 1 to about 3-½ inches wide and about 1 to about 3 inches long. In one embodiment, the pita chips are about 1-¼ to about 2-½ inches wide and about 1-¾ to about 3 inches long.

### G. Optional Finish Steps

In one embodiment, when the unsplit tubes 302 are trimmed 216, the resultant chip-sized pieces mimic traditional pita bread with a crumb side in the center. These “two-layered” pita chips can have higher moisture content inside the pocket than at the surface, so these chips are optionally subjected to a moisture level equilibration or drying 218 step in another RF dryer. The drying step also ensures that any mists trapped inside the pocket during the water jet trimming step 216 is removed. This step also reduces the dwell time of the chip-sized pieces in the final finish cooking stage 222 to the extent that the extra moisture is removed in the drying step 218. The moisture level after the drying step 218 in one embodiment is between about 5 to about 30% water by weight.

After either the trimming step 216 or the optional drying step 218, the resultant product is subjected to an optional cooling step 220. The cooling step 220 occurs in an ambient environment or a spiral cooler in various embodiments. In some embodiments, the cooling takes about 10 minutes in ambient condition.

The individual chip-sized pieces (whether made from split halves 102, 104 or the unsplit tubes 302) are finish cooked 222 to the final moisture content of about 1 to about 2.5% water by weight. The finish cooking step 222 occurs in any cooking device that is capable of removing moisture from the chip-sized pieces. In some embodiments, the finish cooking device is a type of oven, such as a convection oven. Following this step 222, the pita chip products are packaged and shipped. The low moisture content of the final product, typically between about 1 and about 2.5%, allows for longer shelf-life.

There are numerous advantages of Applicants' method 200 all being carried out in an automated, continuous process. Eliminating manual handling decreases labor cost as well as product breakage and the resultant loss. Also, because the bread tubes 302 are not subjected to the variations in conditions during conventional curing, product uniformity is increased. Use of vacuum conveyors 308, 312 or rollers 316, 318 along with a splitting mechanism 310 (whether rotary blades, band saw, or similar devices) also increases product uniformity compared to manually splitting the bread loaves or other mechanical processes. Also, the elimination of lengthy ambient curing and cooling steps obviates the need for separate storage space for the loaves. The flexibility of the Applicants' method 200—i.e., the ability to order several steps interchangeably—adds new dimensions to the pita chip production process. For example, the bread tube 302 can be treated with anti-adhesion liquid, sandwiched with flavored fillings, pressed together, or par-baked in an impingement oven.

In one embodiment, Applicants' new method 200 is made possible by a combination of the various components described herein, including: splitter 300 coupled to vacuum rollers 316, 318, or vacuum conveyors 308, 312, 314, the single-tiered RF dryer, the two-tiered RF dryer, the two-tiered impingement oven, the water jet cutting system 500, and the trimmers 600, 700.

### ILLUSTRATIVE EXAMPLES

One embodiment of the invention is a continuous process and the accompanying equipment for making a chip product, such as pita chips. The process involves cutting sheeted dough into continuous longitudinal strips, and cooking them to form hollow tubes.

In some embodiments, these tubes are split longitudinally, which can be accomplished, for example, using a vacuum-assisted splitter.

In some embodiments, the bread tubes or strips can be cured in an accelerated process.

The bread tube can also be trimmed into chip-sized pieces. For example, in one embodiment, the pita bread strips are cut into chip-sized pieces using a continuous, low-pressure water jet cutting system. The resulting chip-sized pieces are nearly uniform in size, shape, and texture. In one embodiment, the process and equipment comprise a first conveyor, a second conveyor and a first trimmer with a water jet nozzle that is positioned above a gap between the first conveyor and the second conveyor.

### Additional Embodiments

The following clauses are offered as further description of the disclosed invention:
1. A continuous method of making chips, the method comprising the following steps:
   a) sheeting bread dough into a continuous dough sheet;
   b) cutting the continuous dough sheet longitudinally into continuous dough strips;
   c) cooking a continuous dough strip in a continuous oven, thereby producing a continuous bread tube, wherein the continuous bread tube comprises a cavity, a top surface, and a bottom surface;
   d) curing the continuous bread tubes in less than about 60 seconds; and
   e) trimming the continuous bread tubes into chip-sized pieces using a trimmer.
2. The method of clause 1, further comprising proofing the continuous dough sheet after sheeting of step a).
3. The method of clause 1, wherein curing of step d) occurs in a radio frequency oven.
4. The method of clause 1, wherein curing of step d) occurs in a convection oven.
5. The method of clause 1, wherein the continuous bread tube has a cavity moisture level of about 32% by weight after the cooking of step c).
6. The method of clause 1, wherein the continuous bread tube after the curing step d) has a moisture level ranging from about 20 to about 34% by weight.
7. The method of clause 1, further comprising splitting the continuous bread tube longitudinally into a top half and a bottom half using a splitting mechanism prior to the trimming of step e).
8. The method of clause 7, further comprising a spraying step wherein the spraying step comprises spraying the continuous bread tube of step c) with an anti-adhesive liquid to remove tackiness of the top half and the bottom half.
9. The method of clause 1, further comprising spraying the continuous bread tube of step c) with an anti-adhesive liquid to remove tackiness of the top surface and the bottom surface.
10. The method of clause 1, further comprising flattening the continuous bread tube without re-adhering of the top surface and the bottom surface before the trimming step e).
11. The method of clause 1, wherein the trimmer of step e) is a continuous low-pressure water jet cutting system.
12. The method of clause 1, wherein trimming of step e) exposes the cavity.
13. The method of clause 1, further comprising drying the chip-sized pieces after the trimming of step e).
14. The method of clause 1, further comprising cooling the chip-sized pieces after the trimming of step e).
15. A chip produced by the method of clause 1.
16. A continuous method of making chips, the method comprising the following steps:
   a) sheeting bread dough into a continuous dough sheet;
   b) cutting the continuous dough sheet longitudinally into continuous dough strips;
   c) cooking a continuous dough strip in a continuous oven, thereby producing a continuous bread tube, wherein the continuous bread tube comprises a cavity, a top surface, and a bottom surface;
   d) splitting the continuous bread tube longitudinally into a top half and a bottom half using a splitting mechanism assisted by a vacuum apparatus;
   e) curing the continuous bread tube in less than about 60 seconds; and
   f) trimming the continuous bread tubes into chip-sized pieces using a trimmer.
17. The method of clause 16, further comprising proofing the continuous dough sheet after sheeting of step b).
18. The method of clause 16, wherein the vacuum apparatus of step d) comprises a top vacuum conveyor, wherein the top vacuum conveyor is coupled to the top surface of the continuous bread tube.
19. The method of clause 18, wherein the vacuum apparatus of step d) comprises a bottom vacuum conveyor registered with the top vacuum conveyor, wherein the bottom vacuum conveyor is coupled to the bottom surface of the continuous bread tube.
20. The method of clause 16, wherein the splitting mechanism of step d) is coupled to vacuum rollers.
21. The method of clause 16, wherein the splitting mechanism of step d) comprises a plurality of horizontal rotary blades.
22. The method of clause 16, wherein the splitting mechanism of step d) comprises a scallop-edged band saw.
23. The method of clause 16, further comprising applying a filling between the top half and the bottom half of the continuous bread tube after step c).
24. The method of clause 16, wherein the top and the bottom halves of the continuous bread tube formed by step d) are transported together using a single-tier takeaway conveyor.
25. The method of clause 16, wherein the top and bottom halves of the continuous bread tube formed by step d) are transported separately using a top takeaway conveyor and a bottom takeaway conveyor, respectively.
26. The method of clause 16, wherein curing of step e) occurs in a continuous two-tiered radio frequency dryer comprising a top tier and a bottom tier.
27. The chip produced by the method of clause 16.
28. A continuous chip production line comprising a series of unit operation each unit operation in communication with another continuous chip production line comprising:
   a sheeter in communication with a cutter, the cutter in further communication with a cooking oven, the cooking oven in further communication with a first radio frequency dryer, the first radio frequency dryer in further communication with a trimmer.
29. The continuous chip production line of clause 28, further comprising a proofer located between and in communication with the sheeter and the cutter.
30. The continuous chip production line of clause 28, further comprising a splitter located between and in communication with the cooking oven and the first radio frequency dryer.
31. The continuous chip production line of clause 30, wherein the conveyor between the cooking oven and the splitter further comprises a top vacuum conveyor coupled to a top surface of a bread product being transported thereon.
32. The continuous chip production line of clause 31, wherein the conveyor further comprises a bottom vacuum conveyor registered with a top vacuum conveyor, wherein further the bottom vacuum conveyor is coupled to a bottom surface of the bread product transported thereon.
33. The continuous chip production line of clause 30, wherein the splitter comprises a plurality of horizontal rotary blades.
34. The continuous chip production line of clause 30, wherein the splitter comprises scallop-edged band saw.
35. The continuous chip production line of clause 30, wherein the first radio frequency dryer comprises a two-tiered radio frequency dryer comprising a top tier and a bottom tier.
36. The continuous chip production line of clause 30, wherein the conveyor located between the splitter and the first radio frequency dryer comprises a single-tier takeaway conveyor.
37. The continuous chip production line of clause 30, wherein the conveyor located between the splitter and the first radio frequency dryer comprises a top takeaway conveyor and a bottom takeaway conveyor.
38. The continuous chip production line of clause 28, wherein the trimmer comprises a continuous low-pressure water jet cutting system further comprising:
   a pressure system;
   a water collection system;
   a motion system comprising a cutting head and a permeable conveyor system;
wherein the pressure system delivers water under pressure to the cutting head, and
wherein further the permeable conveyor system is located between and is in communication with the first radio frequency oven.
39. The continuous chip production line of clause 28, further comprising a second radio frequency dryer adjacent to and in communication with the trimmer.
40. The continuous chip production line of clause 39, further comprising a cooling system adjacent to and in communication with the second radio frequency dryer.
41. An apparatus for forming chips from a continuous mass of dough comprising a first portion of the continuous mass of dough and thinner strips of the continuous mass of dough, wherein the continuous mass of dough moves in a longitudinal direction along conveyors, wherein the first portion is cut in the longitudinal direction to form the thinner strips, wherein the thinner strips are integral with the first portion, and wherein the thinner strips are cut in a lateral direction to form the chips, said apparatus comprising:
   a first conveyor;
   a second conveyor;
   a first trimmer, wherein the first trimmer is stationary, and wherein the trimmer comprises a liquid jet nozzle;
   wherein a second end of the first conveyor and a first end of the second conveyor are adjacent and spaced apart a first distance to form a gap;
   wherein the first trimmer is positioned above the gap;
   wherein the first conveyor, the second conveyor, and the first trimmer are positioned so that as the first conveyor and the second conveyor move the continuous mass of dough in the longitudinal direction and as the first trimmer cuts the first portion in the longitudinal direction:
the first portion is supported by the first conveyor, and
the thinner strips are supported by the second conveyor; and
wherein a top of the continuous mass of dough is unconstrained.
42. The apparatus of clause 41, wherein the first distance is small enough and the static coefficient of friction between the first conveyor and the first portion is large enough that the first portion resting on the first conveyor under a force of gravity on the first portion does not substantially slip against the first conveyor when the first trimmer cuts the first portion; and
   wherein the first distance is small enough and the static coefficient of friction between the second conveyor and the thinner strips is large enough that the thinner strips resting on the second conveyor under a force of gravity on the thinner strips do not substantially slip against the second conveyor when the first trimmer cuts the first portion.
43. The apparatus of clause 41, wherein the first trimmer comprises a plurality of liquid jet nozzles.
44. The apparatus of clause 41, further comprising a second trimmer, wherein the second trimmer cuts the thinner strips in a lateral direction.
45. The apparatus of clause 41, wherein the second trimmer is moveable.
46. The apparatus of clause 41, wherein the second trimmer comprises a plurality of liquid jet nozzles.
47. The apparatus of clause 41, wherein the second trimmer comprises a single liquid jet nozzle.
48. The apparatus of clause 41, wherein the second trimmer comprises a mechanical cutter.
49. The apparatus of clause 41, wherein the second trimmer travels at a translational velocity of about 100 feet per minute to about 1000 feet per minute.
50. The apparatus of clause 41, wherein the first conveyor and the second conveyor move the continuous mass of dough at the same translational velocity.
51. The apparatus of clause 41, wherein the first conveyor is an endless conveyor and the second conveyor is an endless conveyor.
52. The apparatus of clause 41, wherein the second end of the first conveyor comprises a first static nose bar and wherein the first end of the second conveyor comprises a second static nose bar.
53. The apparatus of clause 41, wherein the first conveyor comprises a first roller and a first conveyor belt and the second conveyor comprises a second roller and a second conveyor belt; wherein the first conveyor belt travels along a portion of a circumference of the first roller and the second conveyor belt travels along a portion of a circumference of the second roller; wherein a second distance is equal to the distance between the axis of rotation of the first roller and the axis of rotation of the second roller; and wherein the second distance is less than about 2.5 inches.
54. The apparatus of clause 41, wherein the continuous mass of dough is partially cooked dough in the form of a bread tube.
55. The apparatus of clause 41, wherein the first conveyor conveys the continuous mass of dough on a solid surface.
56. The apparatus of clause 41, wherein the second conveyor conveys the continuous mass of dough on a mesh surface.
57. The apparatus of clause 41, wherein the first conveyor and the second conveyor convey the continuous mass of dough at about 10 to 100 feet per minute.
58. The apparatus of clause 41, wherein the gap is oriented in the lateral direction.
59. The apparatus of clause 41, wherein the gap is stationary.
60. The apparatus of clause 41, wherein the first distance used to form the gap is about 1/16 to about 1 inch.
61. The apparatus of clause 41, wherein the first trimmer and the second trimmer use a continuous low-pressure liquid jet cutting system.
62. The apparatus of clause 41, wherein the continuous mass of dough is a portion of a bread tube.
63. The apparatus of clause 41, wherein the chips are about 1 to about 3 inches wide.
64. The apparatus of clause 41, wherein the chips are about 1 to about 3 inches long.
65. A chip produced by the apparatus of clause 41.
66. An apparatus for forming chips from a continuous mass of dough comprising a first portion of the continuous mass of dough and thinner strips of the continuous mass of dough, wherein the thinner strips are thinner than the first portion, wherein the thinner strips are integral with the first portion, wherein the continuous mass of dough moves in a longitudinal direction along conveyors, wherein the first portion is cut in the longitudinal direction to form the thinner strips, and wherein the thinner strips are cut in a lateral direction to form the chips, said apparatus comprising:
   a first conveyor;
   a second conveyor;
   a first trimmer, wherein the first trimmer is stationary, and wherein the trimmer comprises a liquid jet nozzle;
   a support;
   wherein a second end of the first conveyor and a first end of the second conveyor are adjacent and spaced apart a first distance to form a gap;
   wherein the support is positioned in the gap;
   wherein the first trimmer is positioned above the gap;
   wherein the first conveyor, the support, the second conveyor, and the first trimmer are positioned so that as the first conveyor and the second conveyor move the continuous mass of dough in the longitudinal direction and as the first trimmer cuts the first portion in the longitudinal direction:
the first portion is supported by the first conveyor and the support, and
the thinner strips are supported by the support and the second conveyor.
wherein a top of the continuous mass of dough is unconstrained.
67. The apparatus of clause 66, wherein the trimmer is stationary.
68. The apparatus of clause 66, wherein the support is stationary.
69. The apparatus of clause 66, wherein the first trimmer is positioned above the support.
70. The apparatus of clause 66, wherein the support comprises an aperture that receives a liquid jet from the trimmer, and wherein the support blocks splashing liquid and mist created when the liquid jet contacts an interior of the support.
71. A continuous method for making chips, the method comprising the following steps:
   f) using a first conveyor to convey a continuous mass of dough to a first trimmer positioned over a gap between the first conveyor and a second conveyor, wherein the first trimmer comprises a liquid jet nozzle;
   g) using the first trimmer to longitudinally trim a first portion of the continuous mass of dough to form thinner strips of the continuous mass of dough, wherein the thinner strips are integral with the first portion; and
   h) conveying the thinner strips on the second conveyor.
72. The continuous method for making chips of clause 71, further comprising the step:
   i) using a second trimmer to laterally trim the thinner strips to form chips.
73. The continuous method for making chips of clause 71, wherein the continuous mass of dough is selected from the group consisting of a partially cooked dough and an uncooked dough.
74. The continuous method for making chips of clause 71, further comprising the steps:
   a) sheeting dough into a continuous dough sheet;
   b) cutting the continuous dough sheet longitudinally into a first set of continuous dough strips; and
   c) cooking a continuous dough strip from the first set of continuous dough strips in a continuous oven, thereby producing a continuous, partially cooked tube of dough, wherein the tube of dough comprises a cavity, a top surface, and a bottom surface; and wherein the tube of dough comprises the continuous mass of dough.
75. The continuous method for making chips of clause 74, wherein the continuous mass of dough is the tube of dough.
76. The continuous method for making chips of clause 74, further comprising the step:
   d) splitting the tube of dough longitudinally into a top half and a bottom half using a splitting mechanism assisted by a vacuum apparatus; wherein the continuous mass of dough is selected from the group consisting of the top half and the bottom half.
77. The continuous method for making chips of clause 74, further comprising the step:
   e) curing the tube of dough in less than about 60 seconds.
78. The continuous method for making chips of clause 71, wherein the first conveyor and the second conveyor convey the continuous mass of dough in a longitudinal direction.
79. The continuous method for making chips of clause 71, wherein the first trimmer is stationary.
80. An apparatus for splitting a continuous mass of dough moving in a longitudinal direction along a conveyor, wherein the continuous mass of dough is split longitudinally to form a first portion of dough and a second portion of dough, said apparatus comprising:
   a first roller;
   a second roller; and
   at least one source of vacuum;
   wherein the first roller comprises a first surface and a first interior, and wherein the first surface comprises a first set of apertures in fluid communication with the first interior;
   wherein the second roller comprises a second surface and a second interior, and wherein the second surface comprises a second set of apertures in fluid communication with the second interior;
   wherein the at least one source of vacuum provides a first vacuum in the first interior and a second vacuum in the second interior; and
   wherein the first roller and the second roller are spaced apart a distance so that the continuous mass of dough can pass between the first roller and the second roller while the first portion is pulled in a first direction by the first roller and while the second portion is pulled in a second direction by the second roller.
81. The apparatus of clause 80, wherein the first roller is positioned above the second roller.
82. The apparatus of clause 80, wherein the first vacuum and the second vacuum are strong enough to split the continuous mass of dough into the first portion and the second portion.
83. The apparatus of clause 80, further comprising cutting equipment for splitting the continuous mass of dough into the first portion and the second portion.
84. The apparatus of clause 83, wherein the first roller and the second roller pull the continuous mass of dough apart while the cutting equipment cuts the continuous mass of dough.
85. The apparatus of clause 83, wherein the cutting equipment is selected from the group consisting of a stationary blade, a band saw, and a rotary blade.
86. The apparatus of clause 83, wherein the cutting equipment comprises an ultrasonic cutter having a blade oriented in a substantially horizontal plane.
87. The apparatus of clause 80, wherein axes of rotation of the first roller and the second roller are transverse to the longitudinal direction.
88. The apparatus of clause 80, wherein the first roller and the second roller are hollow.
89. The apparatus of clause 80,
   wherein the first roller and the second roller comprise a nip;
   wherein the first roller comprises a first stationary manifold;
   wherein the second roller comprises a second stationary manifold; and
      wherein the first stationary manifold generally limits vacuum suction to a vacuum portion of the first roller and the second stationary manifold generally limits vacuum suction to a vacuum portion of the second roller; and
      wherein the vacuum portion of the first roller and the vacuum portion of the second roller are positioned somewhat opposite each other and adjacent to the nip.
90. The apparatus of clause 80, wherein cutting equipment comprising a blade is positioned where the continuous mass of dough exits a nip between the first roller and the second roller; and wherein a cutting edge of the blade is positioned substantially parallel to axes of rotation of the first roller and the second roller; and wherein the cutting edge of the blade is positioned to split the continuous mass of dough into the first portion and the second portion.
91. The apparatus of clause 90, wherein the cutting edge of the blade is positioned at a midway point of the nip between the first roller and the second roller.
92. The apparatus of clause 80, further comprising:
   scrapers to guide the continuous mass of dough into a desired position.
93. The apparatus of clause 83, wherein the cutting equipment is positioned a distance downstream of a nip between the first roller and the second roller.
94. The apparatus of clause 80, further comprising:
   a splitter housing to capture steam from within the continuous mass of dough.
95. A method for splitting a continuous mass of dough, the method comprising the following steps:
   providing a continuous mass of dough, comprising a first portion of dough and a second portion of dough;
   conveying the continuous mass of dough in a direction of conveyance between a first roller and a second roller, wherein the first roller contacts the first portion of dough and the second roller contacts the second portion of dough;
   exposing the first portion of dough to a first vacuum within the first roller and rotating the first roller, thereby pulling the first portion of dough in a first direction;
   exposing the second portion of dough to a second vacuum within the second roller and rotating the second roller, thereby pulling the second portion of dough in a second direction;
   wherein the first direction and the second direction are not the same directions.
96. The method of clause 95 further comprising:
   rotating the first roller and the second roller so that they cooperate to pull the continuous mass of dough between the rollers.
97. The method of clause 95 further comprising:
   rotating the first roller and the second roller at substantially the same angular velocity.
98. The method of clause 95 further comprising:
   rotating the first roller to convey the first portion of dough at a first translational velocity and rotating the second roller to convey the second portion of dough at a second translational velocity, wherein the first and second translational velocities are substantially equal.
99. The method of clause 95 further comprising:
   splitting the continuous mass of dough by using cutting equipment.
100. The method of clause 95 further comprising:
   vibrating a blade at high frequency while using the blade to split the continuous mass of dough.
101. The method of clause 95, wherein the continuous mass of dough is a partially cooked dough.
102. The method of clause 95, wherein the continuous mass of dough is a bread tube.
103. The method of clause 95, wherein the first portion of dough is positioned somewhat opposite the second portion of dough.
104. The method of clause 95 further comprising the steps:
   conveying the continuous mass of dough to the first roller and the second roller in a pre-roller direction with a pre-roller translational velocity; and
   rotating the first roller and the second roller to convey the continuous mass of dough in a post-roller direction with a post-roller translational velocity;
   wherein the pre-roller direction and post-roller direction are substantially the same direction, and wherein the pre-roller translational velocity and post-roller translational velocity are substantially the same translational velocity.
105. The method of clause 95, wherein the first roller and the second roller convey the continuous mass of dough against cutting equipment.
106. The method of clause 95, wherein a size of a nip between the first roller and the second roller is selected so that the first portion of dough that is fixed to the first roller and the second portion of dough that is fixed to the second roller are separated by an intervening gap.
107. The method of clause 95, wherein the first roller conveys the first portion of dough to a first takeaway conveyor and wherein the second roller conveys the second portion of dough to a second takeaway conveyor.
108. The method of clause 107,
   wherein the first roller and the second roller comprise a top roller and a bottom roller;
   wherein the first portion of dough and the second portion of dough comprise a top portion of dough and a bottom portion of dough;
   wherein the first takeaway conveyor and the second takeaway conveyor comprise a top takeaway conveyor and a bottom takeaway conveyor; and
   wherein the top roller conveys the top portion of dough to the top takeaway conveyor and the bottom roller conveys the bottom portion of dough to the bottom takeaway conveyor.
109. The method of clause 95, wherein a stationary manifold in the first roller is positioned to provide a vacuum downstream of a nip between the first roller and the second roller.
110. The method of clause 95, wherein a stationary manifold in the second roller is positioned to provide a vacuum upstream of a nip between the first roller and the second roller.
111. The method of clause 95, wherein the providing step comprises providing a bread tube with a top portion of the bread tube that is separated a distance from a bottom portion of the bread tube; and
   wherein the conveying step comprises conveying the bread tube to the first and second roller before the top portion of the bread tube mends to the bottom portion of the bread tube.
112. The method of clause 95, wherein a translational velocity provided by the first roller to the first portion of dough is different from a translational velocity provided by the second roller to the second portion of dough.
113. The method of clause 95, wherein steam from within the continuous mass of dough is captured in a splitter housing.
114. The method of clause 113, wherein the steam captured in the splitter housing is evacuated by utility equipment selected from the group consisting of the first vacuum, the second vacuum, and a vent.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the spirit and scope of the appended claims and/or disclosure. Alternative embodiments that result from combining, integrating, or omitting features of the embodiments are also within the scope of the disclosure.

Additionally, while this invention is particularly shown and described herein with reference to preferred embodiments, it will be understood by those skilled in the art that various changes in form and detail can be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law.

Moreover, any combination of the elements described herein, in all possible variations thereof, is encompassed by the invention unless otherwise indicated herein or otherwise clearly contradicted by context. For example, after reading the disclosure, a person with ordinary skill in the art would understand that in a method embodying the invention, the method steps can be performed in different orders and method steps can be added or omitted. As another example, after reading the disclosure, a person with ordinary skill in the art would understand that although specific examples of equipment embodying the invention have been described, other embodiments of the invention can be created by combinations of the features and elements described herein. Accordingly, unless otherwise provided, elements of any illustrative embodiment can be added, omitted, substituted, modified, or rearranged to provide a new illustrative embodiment that is within the scope of the inventors' disclosure.

In order to assist the United States Patent and Trademark Office (USPTO) and any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this invention in any way that is not otherwise reflected in the appended claims.

What is claimed is:

1. An apparatus for forming chips from a continuous mass of dough comprising a first portion of the continuous mass of dough and thinner strips of the continuous mass of dough, wherein the continuous mass of dough moves in a longitudinal direction along conveyors, wherein the first portion is cut in the longitudinal direction to form the thinner strips, wherein the thinner strips are integral with the first portion, and wherein the thinner strips are cut in a lateral direction to form the chips, said apparatus comprising:
a first conveyor;
a second conveyor;
a first trimmer, wherein the first trimmer is stationary, and wherein the trimmer comprises a liquid jet nozzle;
wherein a second end of the first conveyor and a first end of the second conveyor are adjacent and spaced apart a first distance to form a gap;
wherein the first trimmer is positioned above the gap;
wherein the first conveyor, the second conveyor, and the first trimmer are positioned so that as the first conveyor and the second conveyor move the continuous mass of dough in the longitudinal direction and as the first trimmer cuts the first portion in the longitudinal direction:
the first portion is supported by the first conveyor, and
the thinner strips are supported by the second conveyor; and
wherein a top of the continuous mass of dough is unconstrained.

2. The apparatus of claim 1, wherein the first distance is small enough and the static coefficient of friction between the first conveyor and the first portion is large enough that the first portion resting on the first conveyor under a force of gravity on the first portion does not substantially slip against the first conveyor when the first trimmer cuts the first portion; and
wherein the first distance is small enough and the static coefficient of friction between the second conveyor and the thinner strips is large enough that the thinner strips resting on the second conveyor under a force of gravity on the thinner strips do not substantially slip against the second conveyor when the first trimmer cuts the first portion.

3. The apparatus of claim 1, wherein the first trimmer comprises a plurality of liquid jet nozzles.

4. The apparatus of claim 1, further comprising a second trimmer, wherein the second trimmer cuts the thinner strips in a lateral direction.

5. The apparatus of claim 1, wherein the second trimmer is moveable.

6. The apparatus of claim 1, wherein the second trimmer comprises a plurality of liquid jet nozzles.

7. The apparatus of claim 1, wherein the second trimmer comprises a single liquid jet nozzle.

8. The apparatus of claim 1, wherein the second trimmer comprises a mechanical cutter.

9. The apparatus of claim 1, wherein the second trimmer travels at a translational velocity of about 100 feet per minute to about 1000 feet per minute.

10. The apparatus of claim 1, wherein the first conveyor and the second conveyor move the continuous mass of dough at the same translational velocity.

11. The apparatus of claim 1, wherein the first conveyor is an endless conveyor and the second conveyor is an endless conveyor.

12. The apparatus of claim 1, wherein the second end of the first conveyor comprises a first static nose bar and wherein the first end of the second conveyor comprises a second static nose bar.

13. The apparatus of claim 1, wherein the first conveyor comprises a first roller and a first conveyor belt and the second conveyor comprises a second roller and a second conveyor belt; wherein the first conveyor belt travels along a portion of a circumference of the first roller and the second conveyor belt travels along a portion of a circumference of the second roller; wherein a second distance is equal to the distance between the axis of rotation of the first roller and the axis of rotation of the second roller; and wherein the second distance is less than about 2.5 inches.

14. The apparatus of claim 1, wherein the continuous mass of dough is partially cooked dough in the form of a bread tube.

15. The apparatus of claim 1, wherein the first conveyor conveys the continuous mass of dough on a solid surface.

16. The apparatus of claim 1, wherein the second conveyor conveys the continuous mass of dough on a mesh surface.

17. The apparatus of claim 1, wherein the first conveyor and the second conveyor convey the continuous mass of dough at about 10 to 100 feet per minute.

18. The apparatus of claim 1, wherein the gap is oriented in the lateral direction.

19. The apparatus of claim 1, wherein the gap is stationary.

20. The apparatus of claim 1, wherein the first distance used to form the gap is about 1/16 to about 1 inch.

21. The apparatus of claim 1, wherein the first trimmer and the second trimmer use a continuous low-pressure liquid jet cutting system.

22. The apparatus of claim 1, wherein the continuous mass of dough is a portion of a bread tube.

23. The apparatus of claim 1, wherein the chips are about 1 to about 3 inches wide.

24. The apparatus of claim 1, wherein the chips are about 1 to about 3 inches long.

25. A chip produced by the apparatus of claim 1.

26. An apparatus for forming chips from a continuous mass of dough comprising a first portion of the continuous mass of dough and thinner strips of the continuous mass of dough, wherein the thinner strips are thinner than the first portion, wherein the thinner strips are integral with the first portion, wherein the continuous mass of dough moves in a longitudinal direction along conveyors, wherein the first portion is cut in the longitudinal direction to form the thinner strips, and wherein the thinner strips are cut in a lateral direction to form the chips, said apparatus comprising:
a first conveyor;
a second conveyor;
a first trimmer, wherein the first trimmer is stationary, and wherein the trimmer comprises a liquid jet nozzle;
a support;
wherein a second end of the first conveyor and a first end of the second conveyor are adjacent and spaced apart a first distance to form a gap;
wherein the support is positioned in the gap;
wherein the first trimmer is positioned above the gap;
wherein the first conveyor, the support, the second conveyor, and the first trimmer are positioned so that as the first conveyor and the second conveyor move the continuous mass of dough in the longitudinal direction and as the first trimmer cuts the first portion in the longitudinal direction:
the first portion is supported by the first conveyor and the support, and
the thinner strips are supported by the support and the second conveyor.
wherein a top of the continuous mass of dough is unconstrained.

27. The apparatus of claim 26, wherein the trimmer is stationary.

28. The apparatus of claim 26, wherein the support is stationary.

29. The apparatus of claim 26, wherein the first trimmer is positioned above the support.

30. The apparatus of claim 26, wherein the support comprises an aperture that receives a liquid jet from the trimmer, and wherein the support blocks splashing liquid and mist created when the liquid jet contacts an interior of the support.

31. A continuous method for making chips, the method comprising the following steps:
f) using a first conveyor to convey a continuous mass of dough to a first trimmer positioned over a gap between the first conveyor and a second conveyor, wherein the first trimmer comprises a liquid jet nozzle;
g) using the first trimmer to longitudinally trim a first portion of the continuous mass of dough to form thinner strips of the continuous mass of dough, wherein the thinner strips are integral with the first portion; and
h) conveying the thinner strips on the second conveyor.

32. The continuous method for making chips of claim 31, further comprising the step:
i) using a second trimmer to laterally trim the thinner strips to form chips.

33. The continuous method for making chips of claim 31, wherein the continuous mass of dough is selected from the group consisting of a partially cooked dough and an uncooked dough.

34. The continuous method for making chips of claim 31, further comprising the steps:
a) sheeting dough into a continuous dough sheet;
b) cutting the continuous dough sheet longitudinally into a first set of continuous dough strips; and
c) cooking a continuous dough strip from the first set of continuous dough strips in a continuous oven, thereby producing a continuous, partially cooked tube of dough, wherein the tube of dough comprises a cavity, a top surface, and a bottom surface; and wherein the tube of dough comprises the continuous mass of dough.

35. The continuous method for making chips of claim 34, wherein the continuous mass of dough is the tube of dough.

36. The continuous method for making chips of claim 34, further comprising the step:
d) splitting the tube of dough longitudinally into a top half and a bottom half using a splitting mechanism assisted by a vacuum apparatus; wherein the continuous mass of dough is selected from the group consisting of the top half and the bottom half.

37. The continuous method for making chips of claim 34, further comprising the step:
e) curing the tube of dough in less than about 60 seconds.

38. The continuous method for making chips of claim 31, wherein the first conveyor and the second conveyor convey the continuous mass of dough in a longitudinal direction.

39. The continuous method for making chips of claim 31, wherein the first trimmer is stationary.
